(19) United States
(12) Patent Application Publication
(10) Pub. No.: US 2017/0245524 A1
(43) Pub. Date: Aug. 31, 2017

(54) FRUIT OR VEGETABLE BEVERAGE ENRICHED WITH FIBER

(71) Applicant: Yissum Research Development Company of the Hebrew University of Jerusalem Ltd., Jerusalem (IL)

(72) Inventor: Amos NUSSINOVITCH, Rehovot (IL)

(73) Assignee: Yissum Research Development Company of the Hebrew University of Jerusalem Ltd., Jerusalem (IL)

(21) Appl. No.: 15/509,720

(22) PCT Filed: Sep. 6, 2015
(86) PCT No.: PCT/IL2015/050896

§ 371 Date: Mar. 8, 2017

Related U.S. Application Data
(60) Provisional application No. 62/047,078, filed on Sep. 8, 2014.

(51) Int. Cl. A23L 2/52; A23L 19/00; A23L 33/22; A23L 2/02

(52) U.S. Cl. CPC A23L 2/52; A23L 2/02; A23L 19/09; A23L 33/22; A23V 2002/00

(57) ABSTRACT

Provided are fortified beverages, in particular fruit or vegetable juices, enriched with fruit or vegetable fiber in a nutritionally effective amount, and methods of manufacture thereof. In particular, the provided are methods for increasing the percentage of dietary fiber in fruit or vegetable tissue mass added to fruit or vegetable juice, thereby providing a fruit or vegetable juice enriched with fruit or vegetable fiber, the methods including at least one step of washing followed by a step of centrifugation, and excluding steps of drying at elevated temperatures or exposure to any chemical treatment.

### FIELD OF THE INVENTION

The present invention relates to methods for increasing the percentage of dietary fiber in fruit or vegetable tissue mass added to a fruit or vegetable juice, thereby providing a fruit or vegetable beverage enriched with fruit or vegetable fiber, the methods comprising at least one step of washing followed by a step of centrifugation, and avoiding steps of tissue mass drying at elevated temperatures or any chemical treatment.

### BACKGROUND OF THE INVENTION

The consumption of dietary fiber plays an important role in the prevention of illnesses such as constipation, hemorrhoids and hypercholesterolemia. Dietary fibers are not only desirable for their nutritional properties but also for their functional and technological properties. Fruit fibers are considered important to the diet due to high total and soluble fiber contents, good functional properties (water and oil holding capacities), good colonic fermentability and low caloric content.

The consumer's increasing awareness of the benefits of natural fiber in the human diet mandates a way to increase the fiber content of beverages. Fruit or vegetable juice industries produce an important quantity of by-products, which due to their high fiber content can be used as a good source of dietary fiber. However, it is known that consumers tend to dislike fruit or vegetable juices or beverages into which large amounts of fruit or vegetable tissue mass are incorporated, at least in part due to organoleptic problems associated with such highly pulpy juices. Such organoleptic problems may be the gelling effect of the soluble fiber and the harsh mouthfeel of the insoluble fiber which is described as gritty. Another problem, particularly with fibers derived from oranges and other citrus products, is an unpleasant or bitter flavor associated with the cellulosic components. In addition, it is well known that pulp adsorbs aroma and flavor ingredients in the beverage. The adsorption of the beneficial volatiles results in a significant deterioration in quality and overall flavor of the beverage. Fiber and pulp can also adsorb undesirable flavors such as oxidation products or cooked flavors.

Methods for recovery and preparation of fruit or vegetable fiber usually involve drying the fruit or vegetable tissue mass which may be followed by milling or grinding the obtained dry tissue mass. Drying fruit or vegetable tissue mass can create burnt or cooked flavors in the fiber. Due to the presence of reducing sugars, the dried, unwashed tissue mass may undergo browning and produce a sticky product causing impairment of flow properties and caking. Additionally, auto-oxidation of lipids and oxidation of essential oils and pigments may result in a rancid flavor of the product and fading of its color. Such degradation products can cause off-flavors in a fiber-containing beverage. Methods for the dehydration of citrus pulp were reviewed in Passy and Mannhein, J. Food Eng. (1983), 2: 19-34.

U.S. Pat. No. 5,073,397 discloses methods for the preparation of ultrafine citrus fiber and derivative fiber-enriched citrus beverages comprising drying and grinding operations, wherein the drying step during which the pulp moisture is reduced to no more than 15%, is done at a temperature of between 120-250° C.

Japanese Patent Application No. JP1983198117 discloses a process for obtaining a fermented drink with a low alcoholic content having improved flavor for drinking. The process comprises adding preliminarily cultivated yeast of the species Kluyveromyces lactis or Kluyveromyces fragilis to a pressed juice of fruit or vegetable, such that an alcoholic fermentation is carried out. Microbial cells are then separated to give fermentation liquor, which may be concentrated and/or dried and adjusted to give the aimed alcohol concentration, preferably of less than 1% (w/v) of ethanol.

There is an unmet need for a natural fruit or vegetable tissue mass enriched with fiber, which can be incorporated into a beverage, thereby providing a beverage enriched with fruit or vegetable fiber in a nutritionally effective amount, said tissue mass fiber enrichment being performed using only physical mechanical procedures (e.g., washing, centrifuging and possible grinding) and avoiding any steps of tissue mass drying at elevated temperatures or by any chemical treatment known in the art, such as liming.

This and other objects of this invention will become apparent by the description of the invention below.

### SUMMARY OF THE INVENTION

The present invention relates to fruit or vegetable juice enriched with dietary fibers, and provides means and methods for producing same. Particularly, the present invention provides a wholly natural process comprising only mechanical procedures, for the enrichment of fruit pulp or certain forms of fruit and vegetable tissue mass with dietary fibers, and use of the enriched tissue mass in the beverages industry to obtain a fiber-enriched beverage. In particular embodiments, the present invention produces a fruit drink that is enriched with fiber containing 1% total dietary fiber, i.e. 2.5 grams of total dietary fiber (TDF) per 250 ml, equivalent to 10% of the Recommended Dietary Intake (which is 25 g/day) of dietary fiber. This product is advantageous compared to other commercial products containing elevated TDF in that it attains the desired enrichment of total dietary fiber (TDF) without exposure to any chemical agents or heating of the pulp or fruit tissue mass and without undesired traits including elevated Brix or viscosity that reaches unpalatable levels.

The present invention is based in part on the unexpected discovery that repeated washes of citrus tissue mass with water at a water to tissue mass ratio of about 1:1 to 1:2, without the addition of any chemical substance and at a temperature which does not exceed 40° C. results in pulp or tissue mass significantly enriched with insoluble dietary fibers that is suitable for fortifying juice beverages without negatively affecting its natural flavor, appearance (color), Brix and viscosity as measured by methods known in the art at the relevant shear rates (40-60 sec⁻¹).

In exemplary embodiments, the fiber enriched citrus pulp was obtained by repeated consecutive steps of washing the citrus pulp with water followed by centrifugation yet, importantly avoiding steps of pulp drying at elevated temperatures or treatment by any chemical treatment commonly known in the art. All steps were performed at ambient or lower temperatures.

According to a first aspect, the present invention provides a fortified beverage comprising:
(a) fruit or vegetable juice; and
(a) at least one added washed fruit or vegetable tissue mass selected from the group consisting of: (i) washed citrus pulp, said washed citrus pulp having a moisture content of at least 85% (w/w of total pulp weight), soluble solid content of up to 2 ° Brix and a total dietary fiber (TDF) of between 3.5-8% (w/w of total pulp weight); (ii) washed comminuted citrus peel, said washed comminuted citrus peel having a moisture content of at least 85% (w/w of total comminuted citrus peel) and a TDF of between 5-10% (w/w of total comminuted citrus peel weight); and a combination thereof; (iii) washed pome fruit tissue mass, said washed pome fruit tissue mass having a moisture content of at least 85% (w/w of total pome fruit tissue mass weight), soluble solid content of up to 2 ° Brix and a total dietary fiber (TDF) of between about 3.5% to about 6% (w/w of total pome fruit tissue mass weight); (iv) washed drupe fruit tissue mass, said washed drupe fruit tissue mass having a moisture content of at least 85% (w/w of total drupe fruit tissue mass weight), soluble solid content of up to 2 ° Brix and a total dietary fiber (TDF) of between about 5% to about 8% (w/w of total drupe fruit tissue mass weight); and (v) washed vegetable tissue mass having a moisture content of at least 85% (w/w of total vegetable tissue mass weight), soluble solid content of up to 2 ° Brix and a total dietary fiber (TDF) of between about 3.5% to about 8% (w/w of total vegetable tissue mass weight).
   wherein the fortified beverage has a TDF of at least 0.8% (w/w of total fortified beverage weight), and a viscosity below 20 cp at a shear rate of 40 (1/sec).

According to some embodiments, the fortified beverage has a viscosity below 10 cp at a shear rate of 40 (1/sec).

According to some embodiments, the fortified beverage further comprises citrus juice sacs having a moisture content of at least 85% (w/w of total citrus juice sacs weight), soluble solid content of up to 2 ° Brix and a total dietary fiber (TDF) of between about 3.5% to about 6% (w/w of total citrus juice sacs weight).

According to some embodiments, the fortified beverage comprises:
(a) at least 65% fruit or vegetable juice; and
(b) 7%-35% (w/w of total fortified beverage weight) of added washed pome fruit tissue mass, said washed pome fruit tissue mass has a moisture content of at least 85% (w/w of total pome fruit tissue mass weight), soluble solid content of up to 2 ° Brix and a total dietary fiber (TDF) of between about 3.5% to about 6% (w/w of total pome fruit tissue mass weight);
   wherein the fortified beverage has a TDF of at least 0.8% (w/w of total fortified beverage weight), and a viscosity of below 10 cp at a shear rate of 40 (1/sec).

According to some embodiments, the washed pome fruit tissue mass has a moisture content of at least 90% (w/w of total tissue mass weight).

According to some embodiments, the washed pome fruit tissue mass is selected from the group consisting of: apple puree, pear puree and any combinations thereof. According to further embodiment, the washed pome fruit tissue mass comprising apple puree.

According to some embodiments, the washed pome fruit tissue mass has a soluble solid content of up to 1.5 ° Brix. According to some embodiments, the washed pome fruit tissue mass has a soluble solid content of less than 1.0 ° Brix. According to some embodiments, the pome fruit tissue mass has a soluble solid content of less than 0.7 ° Brix.

According to some embodiments, the washed pome fruit tissue mass has a soluble solid content of not more than 0.5 ° Brix.

According to some embodiments, the washed pome fruit tissue mass comprises a moisture content of between 88-95% (w/w of total pome fruit tissue mass weight), a total solid content of between 3-6% (w/w of total pome fruit tissue mass weight) with a soluble solid content of between 0.2 to 1.0 ° Brix.

The term “total solid content” as used herein refers to both soluble solid content and insoluble solid content.

According to some embodiments, the fortified beverage comprises:
(a) at least 65% fruit or vegetable juice;
(b) 7%-15% (w/w of total fortified beverage weight) of washed citrus pulp, said washed citrus pulp having a moisture content of at least 85% (w/w of total pulp weight), soluble solid content of up to 2 ° Brix and a total dietary fiber (TDF) of between 3.5-8% (w/w of total pulp weight); and
(c) 0%-10% (w/w of total fortified beverage weight) washed comminuted citrus peel having a TDF of between 5-9% (w/w of total comminuted citrus peel weight);
   wherein the fortified beverage has a TDF of at least 0.8% (w/w of total fortified beverage weight), and a viscosity below 20 cp at a shear rate of 40 (1/sec).

According to some embodiments, the fortified beverage has a viscosity below 10 cp at a shear rate of 40 (1/sec).

According to some embodiments, the fortified beverage further comprises 0%-10% (w/w of total fortified beverage weight) washed juice sacs having a moisture content of at least 85% (w/w of total citrus juice sacs weight), soluble solid content of up to 2 ° Brix and a total dietary fiber (TDF) of between about 3.5% to about 6% (w/w of total citrus juice sacs weight).

According to some embodiments, the citrus pulp may be ground or not ground.

According to some embodiments the washed citrus pulp added to fruit or vegetable juice to form the fortified beverage of the invention has a moisture content of at least 88% (w/w of total pulp weight). According to some embodiments the washed citrus pulp has a moisture content of at least 90%. According to some embodiments the washed citrus pulp has a moisture content of at least 91%. According to some embodiments the washed citrus pulp has a moisture content of at least 92%.

According to some embodiments, the fruit or vegetable tissue mass has a moisture content of above 85% (w/w of the total tissue mass weight). According to some embodiments, the fruit or vegetable tissue mass comprises a soluble solid content of up to 2% (w/w of total tissue mass weight). According to some embodiments, the weight ratio between the insoluble solid content and the soluble solid content in said fruit or vegetable tissue mass is above 2:1. Said tissue mass can be selected from the group consisting of citrus pulp; comminuted citrus peel; and a combination thereof; pome fruit tissue mass; drupe fruit tissue mass; and vegetable tissue mass. In some preferred embodiments, said fruit or vegetable tissue mass is a citrus pulp. According to some embodiments the tissue mass does not contain inedible matter. According to some embodiments the tissue mass excludes citrus peel or seeds. Each possibility represents a separate embodiment of the invention.

According to some embodiments, the washed citrus pulp comprises a total solid content of up to 15% (w/w of total pulp weight). According to some embodiments, the washed citrus pulp has a total solid content of up to 12% (w/w of total pulp weight). According to some embodiments, the washed citrus pulp has a total solid content of up to 10% (w/w of total pulp weight). According to some embodiments, the washed citrus pulp has a total solid content of up to 8% (w/w of total pulp weight). According to some embodiments, the washed citrus pulp has a total solid content of up to 7% (w/w of total pulp weight). According to some embodiments, citrus pulp comprises moisture content of between 88-95% (w/w of total pulp weight) and a total solid content of between 5-12% (w/w of total pulp weight).

According to some embodiments, the washed citrus pulp has a soluble solid content of up to 1.5 ° Brix. According to some embodiments, the washed citrus pulp has a soluble solid content of less than 1.0 ° Brix. According to some embodiments, the washed citrus pulp has a soluble solid content of less than 0.7 ° Brix. According to some embodiments, the washed citrus pulp has a soluble solid content of not more than 0.5 ° Brix. According to some embodiments, the citrus pulp comprises moisture content of between 88-95% (w/w of total pulp weight), a total solid content of between 5-12% (w/w of total pulp weight) with a soluble solid content of between 0.2 to 1.0 ° Brix. According to some embodiments, the citrus pulp comprises moisture content of between 91-95% (w/w of total pulp weight), a total solid content of between 5 to 9% (w/w of total pulp weight) with a soluble solid content of between 0.2 to 0.6 ° Brix.

According to some embodiments, the fortified beverage comprises (i) fruit or vegetable juice being a conventionally extracted single strength juice having less than 0.3% TDF (w/w of total fruit juice weight); (ii) 7%-13% (w/w of total fortified beverage weight) washed citrus pulp, said washed citrus pulp having a moisture content of at least 85% (w/w of total pulp weight), soluble solid content of up to 2 ° Brix and a total dietary fiber (TDF) of between 3.5-8% (w/w of total pulp weight).

In some embodiments, the fortified beverage further comprises between 3%-6% (w/w of total fortified beverage weight) washed juice sacs having a moisture content of at least 85% (w/w of total citrus juice sacs weight), soluble solid content of up to 2 ° Brix and a total dietary fiber (TDF) of between about 3.5% to about 6% (w/w of total citrus juice sacs weight); wherein the obtained fortified beverage comprises a TDF of at least 0.8% (w/w of total fortified beverage weight), and viscosity below 10 cp at a shear rate of 40 (1/sec).

According to another aspect, the fortified beverage comprises:
(b) at least 65% fruit or vegetable juice;
(c) 7%-35% (w/w of total fortified beverage weight) of washed drupe fruit tissue mass, said washed drupe fruit tissue mass having a moisture content of at least 85% (w/w of total drupe fruit tissue mass weight), soluble solid content of up to 2 ° Brix and a total dietary fiber (TDF) of between about 5% to about 8% (w/w of total drupe fruit tissue mass weight);
   wherein the fortified beverage has a TDF of at least 0.8% (w/w of total fortified beverage weight), and a viscosity of below 10 cp at a shear rate of 40 (1/sec).

According to some embodiments, the washed drupe fruit tissue mass has a soluble solid content of up to 1.5 ° Brix. According to some embodiments, the washed drupe fruit tissue mass has a soluble solid content of less than 1.0 ° Brix. According to some embodiments, the washed drupe fruit tissue mass has a soluble solid content of less than 0.7 ° Brix. According to some embodiments, the washed drupe fruit tissue mass has a soluble solid content of not more than 0.5 ° Brix.

According to some embodiments, the washed drupe fruit tissue mass comprises moisture content of between 88-95% (w/w of total drupe fruit tissue mass weight), a total solid content of between 5-12% (w/w of total drupe fruit tissue mass weight) with a soluble solid content of between 0.2 to 1.0 ° Brix. According to some embodiments, the washed drupe fruit tissue mass comprises moisture content of between 91-95% (w/w of total drupe fruit tissue mass weight), a total solid content of between 5 to 9% (w/w of total drupe fruit tissue mass weight) with a soluble solid content of between 0.2 to 0.6 ° Brix.

According to some embodiments, the washed drupe fruit tissue mass is selected from the group consisting of: washed mango puree, washed peach puree, washed apricot puree and any combinations thereof.

According to some embodiments, the fortified beverage has a lower Brix value than the fruit or vegetable juice. According to some embodiments, acidity of the fortified beverage is substantially similar to the acidity of the fruit or vegetable juice.

According to some embodiments, the fortified beverage of the present invention comprising:
(a) at least 65% fruit or vegetable juice; and
(b) 7%-35% (w/w of total fortified beverage weight) of added washed vegetable tissue mass, said washed vegetable tissue mass having a moisture content of at least 85% (w/w of total vegetable tissue mass weight), soluble solid content of up to 2 ° Brix and a total dietary fiber (TDF) of between about 3.5% to about 6% (w/w of total vegetable tissue mass weight);
   wherein the fortified beverage has a TDF of at least 0.8% (w/w of total fortified beverage weight), and a viscosity of below 10 cp at a shear rate of 40 (1/sec).

According to some embodiments, the vegetable tissue mass is selected from the group consisting of: tomato tissue mass, carrot tissue mass and a combination thereof.

According to some embodiments, the fruit or vegetable juice of step (a) has less than 0.5% TDF (w/w of total fortified beverage weight).

According to some embodiments, the amount of the washed fruit or vegetable tissue mass in the fortified beverage is range between 7%-13% (w/w of total fortified beverage weight). According to other embodiments, the fortified beverage comprises between 9%-13% (w/w of total fortified beverage weight) washed fruit or vegetable tissue mass. According to some embodiments, the fortified beverage comprises between 7%-13% (w/w of total fortified beverage weight) washed fruit or vegetable tissue mass.

According to some embodiments the fortified beverage further comprises between 0%-5% (w/w of total fortified beverage weight) citrus juice sacs.

According to some embodiments, the fortified beverage of the present invention has a TDF of at least 1% (w/w of total beverage weight).

According to some embodiments, the fortified beverage has a viscosity below 7 cp at a shear rate of 40 (1/sec). According to some embodiments, the particles of the fruit or vegetable tissue mass have a wide particle-size distribution. According to an exemplary embodiment the particles of the tissue mass have a Feret's diameter of between about 1 to about 1000 microns. According to some embodiments, the particles of the tissue mass have a Feret's diameter below 50 microns. According to other embodiments, the particles of the tissue mass have a Feret's diameter of above 50 microns.

According to some embodiments, the fortified beverage of the invention has a TDF of at least 0.8% (w/w of total beverage weight). According to some embodiments, the fortified beverage of the invention has a TDF of about 1.0% (w/w of total beverage weight). According to some embodiments, a 250 ml serving of the fortified beverage of the invention provides about 2.5 g fiber, which is 10% of the Recommended Dietary Intake (25 g/day).

It is to be emphasized that one of the major obstacles in enriching fruit or vegetable juices with natural fibers is maintaining a sensory acceptable viscosity of the fortified juice. Although fiber enriched beverages have been described in the art, it is maintained that the addition of above 2 gr of fiber per juice serving makes the product more viscous. In order to obtain a reproducible result the measurement of viscosity may be performed on the beverage after filtration, as is known in the art.

In contrast, the fortified beverage of the invention has a viscosity of less than 20 cp at shear rate of between 40-60 1/sec. According to some embodiments, the fortified beverage of the invention has a viscosity of less than 10 cp at shear rate of between 40-60 1/sec. According to some embodiments, the fortified beverage of the invention has a viscosity of less than 7 cp at shear rate of between 40-60 1/sec. According to some embodiments, the fortified beverage of the invention has a viscosity of less than 5 cp at shear rate of between 40-60 1/sec.

Any fruit or vegetable juice may be used to make the fortified beverage of the present invention. According to some embodiments the fruit juice may be selected from the group consisting of citrus juices, mango juice, apple juice, pear juice, cranberry juice, peach juice, plum juice, apricot juice, nectarine juice, grape juice, cherry juice, currant juice, raspberry juice, gooseberry juice, blackberry juice, blueberry juice, strawberry juice, tomato juice, pineapple juice, coconut juice, pomegranate juice, guava juice, kiwi juice, papaya juice, watermelon juice, cantaloupe juice and mixtures thereof. Each possibility represents a separate embodiment of the present invention. According to another embodiment, the citrus juice is selected from the group consisting of orange juice, lemon juice, grapefruit juice, tangerine juice, clementine juice, tangelo juice, pomelo juice, sweetie juice, lime juice and mixtures thereof. Each possibility represents a separate embodiment of the present invention. According to an exemplary embodiment the fruit juice is selected from the group consisting of: orange juice, mango juice, apple juice and any mixtures thereof. Each possibility represents a separate embodiment of the present invention. In some exemplary embodiments, the juice is a citrus juice. In further exemplary embodiments, the juice is an orange juice. In additional exemplary embodiments, the juice is a mango juice. In yet another exemplary embodiment, the juice is an apple juice.

Any vegetable juice may be used to make the fortified beverage of the present invention. According to some embodiments, the vegetable juice is selected from the group consisting of: tomato juice, carrot juice and any mixtures thereof. Each possibility represents a separate embodiment of the present invention.

According to alternative embodiments the enriched or fortified beverage may be a fruit drink or a fruit nectar product that does not contain the necessary natural juice content to qualify to be labeled with the term fruit juice.

According to another embodiment, the fruit or vegetable juice is selected from the group consisting of natural squeezed fruit or vegetable juice (i.e. conventionally extracted single-strength juice) being pasteurized or unpasteurized, reconstituted juice from concentrate, nectar juice and dehydrated fruit or vegetable juice.

More specifically, the juice may be the primary juice from a juice extractor such as an FMC extractor or may be a juice obtained by finishing and/or pasteurizing or homogenizing a juice.

According to some embodiments, the fruit or vegetable juice used to make the fortified beverage of the present invention has less than 0.5% TDF (w/w of total fruit or vegetable juice weight). According to some embodiments, the fruit or vegetable juice used to make the fortified beverage of the present invention has less than 0.4% TDF (w/w of total fruit or vegetable juice weight). According to some embodiments, the fruit or vegetable juice used to make the fortified beverage of the present invention has less than 0.3% TDF (w/w of total fruit or vegetable juice weight).

According to some embodiments, the fortified fruit or vegetable beverage of the present invention further comprises at least one additive selected from the group consisting of: minerals, vitamins, colorants, flavoring agents, preservatives, electrolytes and any combinations thereof. Each possibility represents a separate embodiment of the present invention.

According to some embodiments, the vitamins selected from the group consisting of: ascorbic acid (Vitamin C), Vitamin E, Vitamins B1 (thiamin), B2 (riboflavin), B6 (pyridoxamine), B12 (cyanocobalamine) and Vitamin B complexes. Components of a Vitamin B complex include vitamins B1, B2, B6, B12, biotin, niacin, pantothenic acid, folic acid, adenine, choline, adenosine phosphate, orotic acid, pangamic acid, carnitine, 4-aminobenzoic acid, myo-inositol, liponic acid and/or amygdaline.

Beneficial minerals that may be included in the fortified beverages include calcium, iron, magnesium and zinc. Electrolytes that would be suitable for inclusion include sodium, potassium and magnesium in the form of their chloride and/or bicarbonate salts.

According to some embodiments, additional ingredients may be further included in the fortified beverages. Such ingredients include preservatives such as benzoic acid or sorbic and salts thereof, sulfur dioxide, butylated hydroxyanisole, butylated hydroxytoluene, etc. Colors, preferably those derived from natural sources, can be added. Salt such as sodium chloride, and other flavor enhancers can be used to improve the flavor of the beverage. Emulsifiers can also be included in the beverage. Any food grade emulsifier can be used. Edible emulsifiers include mono and di-glycerides of long chain fatty acids, preferably saturated fatty acids, and most preferably, stearic and palmitic acid mono and diglycerides. Propylene glycol esters are also useful in the beverage mixes.

According to a another aspect, the present invention provides a process for enriching a fruit or vegetable tissue mass with dietary fiber, said fruit or vegetable tissue mass being adapted for addition to a fruit or vegetable juice to increase the fiber content thereof; the process comprising the steps of: (i) obtaining a wet fruit or vegetable tissue mass having a water content of from about 50% to about 90%; and (ii) washing the fruit or vegetable tissue mass, said washing step comprising adding water to the fruit or vegetable tissue mass followed by centrifugation or filtration, thereby obtaining a washed fruit or vegetable tissue mass enriched with dietary fiber; with the proviso that the process does not include subjecting the fruit or vegetable tissue mass to temperatures above 40° C.

The removal of water from the washed fruit or vegetable tissue mass is done by centrifugation or filtration and does not involve the steps of tissue mass drying at elevated temperatures, water removal under low pressure or any chemical treatment. In some embodiments, the process does not include a step of pasteurization of the fruit or vegetable tissue mass.

It is to be emphasized that the process of the invention excludes subjecting the fruit or vegetable tissue mass to temperatures above 40° C., preferably to temperatures above 35° C., more preferably to temperatures above 30° C. and most preferably to temperatures above 20-25° C. All steps included within the process for enriching a fruit or vegetable component with dietary fiber according to the present invention are performed at temperature lower than 40° C.; preferably at temperatures lower than 35° C.; preferably at temperatures lower than 30° C.; preferably at temperatures lower than 25° C. All steps included within the process for enriching a fruit or vegetable component with dietary fiber according to the present invention are performed at temperatures ranging from 4° C. and 40° C. According to some embodiments all the steps are performed at a temperature ranging from 4° C. to 20° C. According to other embodiments all the steps are performed from 20° C. to 40° C. Each possibility represents a separate embodiment of the present invention.

According to some embodiments, the fruit tissue mass comprises a pome fruit puree selected from the group consisting of: apple puree, pear puree and a combination thereof.

According to some embodiments, the fruit tissue mass consists of an apple puree.

According to some embodiments, the fruit tissue mass comprises a citrus tissue mass selected from the group consisting of:
(i) citrus pulp having a water content of from about 50% to about 90% and comprises, on a wet basis, from about 60% to about 99.99% citrus sacs and membranes, from 0% to about 40% citrus peel and from 0% to about 10% citrus seed; and
(ii) citrus peel having a water content of from about 50% to about 90% and comprises, on a wet basis, from about 50%-99.99% peel; and any combination thereof. Each possibility represents a separate embodiment of the present invention.

According to some embodiments, the citrus pulp may be either ground or un-ground or a combination of ground and unground pulp. According to some embodiments grinding is avoided. The grinding of the citrus pulp may be performed before or after the washing step. In cases where more than one step of washing is required, the grinding may be performed in between washings. The grinding of the pulp may be performed using any grinding method known in the art, for example by using a ball mill grinder. Alternative or additional forms of size reduction may be employed as are well known in the art, with the exclusion of any steps involving heating above 40° C. or chemical treatments. In some preferred embodiments, the process for enriching a fruit or vegetable tissue mass with dietary fiber does not include a grinding step of said tissue mass.

According to some embodiments, the fruit tissue mass is a drupe fruit tissue mass selected from the group consisting of: mango puree, peach puree, apricot puree and any combinations thereof.

According to some embodiments, the process of the present invention for enriching a fruit or vegetable component with dietary fiber comprises an additional step of centrifugation of the washed fruit or vegetable tissue mass without adding water for further reducing the water content of the obtained washed fruit or vegetable tissue mass enriched with fiber.

In order to obtain the desired TDF content and to lower the soluble solid content, the washing step is repeated until the obtained washed fruit or vegetable tissue mass has a soluble solid content of about 1.0° Brix or lower. According to some embodiments the washing step is repeated until the obtained washed fruit or vegetable tissue mass has a soluble solid content of about 0.7 ° Brix or lower. According to some embodiments, the washing step is repeated until the obtained washed fruit or vegetable tissue mass has a soluble solid content of about 0.5 ° Brix. It is to be emphasized that the washing step may be repeated at least two, three times or even more until the desired soluble solid content is obtained. The number of washings depends on the ratio between the volume of water added to the tissue mass and the amount of tissue mass. The bigger the volume of the water added to the tissue mass, the fewer number of washing steps are required in order to obtain the desired soluble content.

According to some embodiments, the washing step comprises adding water to the tissue mass at a ratio of between about 1:10 and about 10:1; alternatively, between about 1:5 and about 5:1; alternatively, between about 1:2 and about 2:1, alternatively, between about 1:1 and about 1:3. Each possibility represents a separate embodiment of the present invention. According to some embodiments, one washing step at a weight ratio between water to tissue mass of between about 1:1.5 and about 1:3 was sufficient to obtain a washed tissue mass having a soluble solid content of about 0.5 ° Brix. According to certain embodiments, five washing steps at a weight ratio water to tissue mass of between about 1:1 and 1:3 or even 1:1 to 1:2 were sufficient to obtain a TDF content of between 4.5-8% (w/w of total pulp weight).

According to some embodiment, centrifugation of the washed tissue mass is typically done at a temperature lower than 25° C., alternatively at a temperature between 15-25° C., in an exemplary embodiment at 20° C.

According to some embodiment, centrifugation of the washed tissue mass at 50,000 RPM (20° C.) is done for about 10 minutes, preferably for about 20 minutes, more preferably for about 5-20 minutes. Each possibility represents a separate embodiment of the invention.

According to some embodiments the centrifugation of the washed tissue mass at 10,000 RPM (20° C.) is done for about 10 minutes, preferably for about 5 minutes. Each possibility represents a separate embodiment of the invention.

According to some embodiments, the water type used in the washing step is distilled water.

According to some embodiments, the process of the present invention further comprises a step of shaking the fruit or vegetable tissue mass for about one to five seconds.

According to further embodiments, the process of the present invention further comprises a step of shaking the fruit or vegetable tissue mass for about one, two, three, four or five seconds. Each possibility represents a separate embodiment of the invention. In an exemplary embodiment, the shaking is performed for about three minutes.

According to another aspect, the present invention provides a process for making a fortified beverage comprising the steps of:
a. obtaining a fruit or vegetable juice;
b. adding to the fruit or vegetable juice at least one washed fruit or vegetable tissue mass prepared by a process comprising the steps of:
   i. obtaining a wet fruit or vegetable tissue mass having a water content of from about 50% to about 90%; and
   ii. washing the fruit or vegetable tissue mass, said washing step comprising adding water to the fruit or vegetable tissue mass followed by centrifugation or filtration, thereby obtaining a washed fruit or vegetable tissue mass enriched with dietary fiber, with the proviso that the process for enriching the fruit or vegetable tissue mass does not include subjecting the fruit or vegetable tissue mass to temperatures above 40° C.;
      thereby obtaining a fortified beverage having a TDF of at least 0.8% (w/w of total fortified beverage weight).

According to some embodiments, the fortified beverage has a viscosity of below 10 cp at a shear rate of 40 (1/sec).

According to some embodiments, the washed fruit tissue mass comprises a pome fruit puree selected from the group consisting of: apple puree, diced pear puree and a combination thereof.

According to some embodiments, the washed fruit tissue mass added to the juice consists of apple puree.

According to some embodiments, the fruit tissue mass comprises a citrus tissue mass having at least one citrus component selected from the group consisting of: (i) washed citrus pulp, said washed citrus pulp has a moisture content of at least 85% (w/w of total pulp weight), soluble solid content of up to 2 ° Brix and a total dietary fiber (TDF) of between 3.5-8% (w/w of total pulp weight); (ii) washed comminuted citrus peel, said washed comminuted citrus peel has a moisture content of at least 85% (w/w of total comminuted citrus peel) and a TDF of between 5-10% (w/w of total comminuted citrus peel weight).

According to some embodiments, the citrus tissue mass further comprises washed juice sacs having a moisture content of at least 85% (w/w of total citrus juice sacs weight), soluble solid content of up to 2 ° Brix and a total dietary fiber (TDF) of between about 3.5% to about 6% (w/w of total citrus juice sacs weight).

According to some embodiments, the citrus tissue mass comprises: 7%-15% (w/w of total fortified beverage weight) washed citrus pulp, said washed citrus pulp has a moisture content of at least 85% (w/w of total pulp weight), soluble solid content of up to 2 ° Brix and a total dietary fiber (TDF) of between 3.5-8% (w/w of total pulp weight); 0%-10% (w/w of total fortified beverage weight) washed comminuted citrus peel having a TDF of between 5-9% (w/w of total comminuted citrus peel weight).

According to some embodiments, the citrus tissue mass further comprises 0%-10% (w/w of total fortified beverage weight) washed juice sacs having a moisture content of at least 85% (w/w of total citrus juice sacs weight), soluble solid content of up to 2 ° Brix and a total dietary fiber (TDF) of between about 3.5% to about 6% (w/w of total citrus juice sacs weight).

According to some embodiments, 9%-13% (w/w of total fortified beverage weight) of the washed citrus pulp and 1-6% washed juice sacs are added to the juice.

According to some embodiments, the fruit or vegetable pulp is ground. According to other embodiments, the fruit or vegetable pulp is un-ground.

According to some embodiments, the washed fruit or vegetable tissue mass is un-ground. In further embodiments, the process for making a fortified beverage does not include a step of grinding the fruit or vegetable tissue mass. The fruit or vegetable tissue mass cam be selected from the group consisting of citrus pulp; comminuted citrus peel; and a combination thereof; pome fruit tissue mass; drupe fruit tissue mass; and vegetable tissue mass. Each possibility represents a separate embodiment of the invention. Without wishing to being bound by any theory or mechanism of action, it is believed that a fortified beverage, comprising ground washed fruit or vegetable tissue has a higher viscosity than a fortified beverage, comprising un-ground tissue mass. It has been shown that grinding of the washed fruit or vegetable tissue mass reduces the TDF of the tissue mass, thus requiring addition of a larger amount of the enriched tissue mass to a fruit or vegetable juice to obtain a desired TDF content, while addition of a larger amount of the tissue mass increases the viscosity of the fortified beverage.

According to some embodiments, the fruit tissue mass comprises a drupe fruit tissue mass selected from the group consisting of: mango puree, peach puree and apricot puree.

According to some embodiments the fortified beverage obtained by the methods of the present invention has a TDF of at least 0.8% (w/w of total fortified beverage weight), and viscosity below 10 cp at a shear rate of 40 (1/sec). According to some embodiments, the fortified beverage obtained by the methods of the present invention has a TDF of at least 1.0% (w/w of total fortified beverage weight), and viscosity below 7 cp at a shear rate of 40 (1/sec).

According to some embodiments, the fruit or vegetable tissue mass added to the fruit juice in order to obtain the fortified beverage of the invention comprises: 7%-15% (w/w of total fortified beverage weight) washed fruit or vegetable tissue mass, said washed fruit or vegetable tissue mass having a moisture content of at least 85% (w/w of total pulp weight), soluble solid content of up to 2 ° Brix and a total dietary fiber (TDF) of between 4.5-8% (w/w of total pulp weight);

According to some embodiments, the fruit or vegetable tissue mass further comprises 0%-10% (w/w of total fortified beverage weight) washed comminuted citrus peel having a TDF of between 5-9% (w/w of total comminuted citrus peel weight). According to further embodiments, the fruit or vegetable tissue mass further comprises 0%-10% (w/w of total fortified beverage weight) washed citrus juice sacs having a moisture content of at least 85% (w/w of total citrus juice sacs weight), soluble solid content of up to 2 ° Brix and a total dietary fiber (TDF) of between about 3.5% to about 6% (w/w of total citrus juice sacs weight).

According to some embodiments, the process for making a fortified beverage does not include a step of pasteurization of the washed fruit or vegetable tissue mass prior to adding said tissue mass to a fruit or vegetable juice. According to other embodiments, the process for making a fortified beverage does not include a step of pasteurization of the washed fruit or vegetable tissue mass separately from the juice.

According to some embodiments, addition of the washed fruit or vegetable tissue mass to the fruit or vegetable juice decreases Brix of said juice. In further embodiments, addition of the washed fruit or vegetable tissue mass to the fruit or vegetable juice does not decrease acidity of the juice.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1 is a line graph showing the viscosity of commercial juice (▪),fortified orange juice with 13% comminuted peel washed once (▴), and fortified juice with 13% comminuted peel washed in 5 runs ().

FIG. 2 shows particle-size distribution (Feret) in washed orange pulp.

FIG. 3 shows particle-area distribution in washed orange pulp.

FIG. 4 shows the particle-area distribution in four washed and ground samples. The number of particles observed is shown on the Y axis, while the X axis represents the tested samples. Stripped bars represent particle area of 0-1000 mm², dotted bars represent particle area of 1000-5000 mm² and brick bars represent particle area of above 5000 mm²,

FIG. 5 shows the particle-area distribution in four washed and ground samples. The percentage of particles from total observed is shown on the Y axis, while the X axis represents the tested samples. Stripped bars represent particle area of 0-1000 mm², dotted bars represent particle area of 1000-5000 mm² and brick bars represent particle area of above 5000 mm², FIGS. 6A-6C show mango pulps unwashed (FIG. 6A), washed (FIG. 6B) and washed and ground (FIG. 6C).

FIGS. 7A-7C show dry mango pulp unwashed (FIG. 7A), washed (FIG. 7B) and washed and ground (FIG. 7C).

### DETAILED DESCRIPTION OF THE INVENTION

The present invention relates to methods for increasing the percentage of dietary fiber in a fruit or vegetable tissue mass such as fruit pulp or puree or comminuted citrus peel, added to fruit or vegetable juice, thereby providing a fruit or vegetable beverage enriched with fruit or vegetable fiber. More specifically, the methods of fruit or vegetable tissue mass enrichment with fiber comprise at least one step of washing followed by at least one step of centrifugation, and avoid steps of tissue mass drying at elevated temperatures or by any chemical or enzymatic treatments.

The enriched fruit or vegetable tissue mass obtained by methods of the present invention comprises between 4.5% and 8% (w/w) of total dietary fiber, moisture content of at least 85% and a soluble solid content of 0.2-2° Brix. The methods of the present invention are suitable for increasing the percentage of dietary fiber in a fruit or vegetable tissue mass by at least 40%, at least 50%, at least 60% and by at least 70%, or even higher. In some cases the fiber content may be increased by twofold (200%), threefold (300%), or even higher.

### Definitions

As used herein the term “tissue mass” refers to a wet fruit or vegetable fiber component, such as, but not limited to: fruit or vegetable pulp, fruit or vegetable puree, diced fruit or vegetable, fruit or vegetable peel, fruit sacs and membranes, or any combinations thereof.

As used herein the terms “pulp” refers to a plant matter remaining after a process, such as the extraction of juice by pressure, has been completed. In some embodiments, the pulp may refer to the soft, succulent part of a plant. In some embodiments, the pulp is composed of mesocarp. In some embodiments, the pulp does not include a peel.

As used herein the term “puree” refers to a plant matter remaining after a process, such as peeling and coring of the plant followed by grinding of its flesh.

As used herein the term “diced” refers to plant matter cut into pieces, optionally with subsequent grinding.

According to some embodiments, the peeling procedure can be performed by any means known in the art, including but not limited to, mechanical means. such as abrasion or peeling with knives, and flash steam peeling Other methods may be used including flame peeling or caustic peeling, as long as the plant tissue mass to be used in the processes and compositions is not exposed to chemicals or high temperatures.

As used herein the term “juice sacs” or “whole juice sacs” refer to the waste streams obtained after straining or settling or centrifuging of raw citrus juice. The juice sacs account for 10-20% of the total refuse from citrus juice and are separated from the juice in a “finisher”.

The term “comminuted citrus” as used herein refers to a whole citrus fruit and its components which have been comminuted.

According to some embodiment, the comminuted citrus includes at least one citrus component selected from the group consisting of: citrus pulp, citrus sacs and membranes, citrus peel and any combinations thereof.

In some embodiments, the comminuted citrus refers to a puree made from whole fruit. In another embodiment the comminuted citrus includes at least one fruit component selected from the group consisting of: citrus pulp having a water content of from about 50% to about 90% and comprises, on a wet basis, from about 60% to about 99.99% citrus sacs and membranes, from 0% to about 40% citrus peel and from 0% to about 10% citrus seed.

In an exemplary embodiment the comminuted fruit refers to comminuted citrus including both albedo and flavedo. The comminution of citrus may be accomplished by cutting, slicing, milling, hammering, mashing, or grinding the fruit or vegetable. Selected size reduction equipment may include hammer mill, disc mills, ball mill, Buhr mill, pin mill and other types of mills well known in the art.

The term “total dietary fiber” as used herein refers to plant substances not digested by human digestive enzymes, including plant cell wall substances (cellulose, hemicelluloses, pectin and lignin) as well as intercellular polysaccharide such as gums and mucilage.

The term “total solid content” or “total solid matter” as used herein refers to the soluble solid content and the insoluble solid content.

The term “Brix” as used herein refers to the total soluble solids content in the fruit or vegetable tissue mass. Degrees Brix (symbol ° Bx), also known as Brix value, is the sugar content of an aqueous solution. One degree Brix is 1 gram of sucrose in 100 grams of solution and represents the strength of the solution as percentage by weight (% w/w).

The term “vegetable” as used herein refers to a plant cultivated for an edible part which is succulent and can be squeezed, for example, by way of non-limiting manner celery, carrots, tomato or any combination thereof.

According to some embodiments, the vegetable is selected from the group consisting of: leafy vegetables, salad vegetables, pod vegetables, bulb vegetables, stem vegetables and root vegetables.

As used herein, the term “about”, when referring to a measurable value such as an amount, a temporal duration, and the like, is meant to encompass variations of +/−10%, in some instances +/−5%, in other instances +/−1%, from the specified value, as such variations are appropriate to perform the disclosed methods.

The tissue mass:

The tissue mass is a wet fruit or vegetable fiber component having water content of from about 50% to about 90%; preferably from about 60% to 88%; preferably from about 75% to 85%.

The fruit or vegetable tissue mass may be a (i) citrus pulp having, on a wet basis, from about 60% to about 99.99% sacs and membranes, from 0% to about 40% peel and from 0% to about 10% seed and (ii) comminuted citrus peel having a water content of from about 50% to about 90% and comprises, on a wet basis, from about 50%-99.99% peel. The citrus pulp is screened from the juice using conventional pulp separation equipment, such as, by way of a non-limited example, a finisher.

It is to be emphasized that the tissue mass is kept wet, and its water content is kept above 50% at all times. The tissue mass is not subjected to any conventional drying procedures such as hot air drying, drum drying, fluid-bed drying and hot oven drying. No freeze dehydration also known as lyophilization is used either.

The fruit or vegetable tissue mass may also be a wet comminuted citrus peel having on a wet basis, from about 50%-99.99% peel. According to some embodiments, the comminution of the citrus peel can be performed to the whole fruits or its components reduced into minute particles. According to some embodiments, the comminution of the citrus peel comprising the steps of crushing the fruit followed by further grinding. In some embodiments, the grinding step is performed for about three times in order to achieve a predetermined size or size distribution of particles of the tissue mass. It will be understood that the comminution of the peel may be accomplished by cutting, slicing, milling, hammering, mashing, grinding the peel, or by combinations of said actions. In the event that the comminution of the peel results in a relatively large particle size variation, the larger particle size fraction of the ground peel material, may be recycled through known in the art comminution apparatus to reduce the larger peel particles of such fraction to smaller sizes. According to some embodiments the fruit is selected from the group consisting of: apple, citrus, mango, peach, apricot, pear, cranberry juice and any combination thereof. Each possibility represents a separate embodiment of the present invention. Non-limiting example of suitable orange fruit include Valencia orange fruit (e.g. Florida Valencia fruit, California Valencia fruit and Brazilian Valencia fruit), Florida oranges (e.g. Hamlin, Parson Brown and Pineapple), Brazilian varieties such as Pera Rio and Natal, Spanish varieties, Israeli varieties as well as Tangerines, Mandarin Oranges and Blood Oranges. Other citrus fruits that can be used in this process include grapefruit, lemons, limes and similar citrus fruits.

Furthermore, the present invention provides a fortified beverage comprising: (a) fruit or vegetable juice; and (b) at least one added washed fruit or vegetable tissue mass selected from the group consisting of: (i) washed citrus pulp, said washed citrus pulp having a moisture content of at least 85% (w/w of total pulp weight), soluble solid content of up to 2 ° Brix and a total dietary fiber (TDF) of between 3.5-8% (w/w of total pulp weight); (ii) washed comminuted citrus peel, said washed comminuted citrus peel having a moisture content of at least 85% (w/w of total comminuted citrus peel) and a TDF of between 5-10% (w/w of total comminuted citrus peel weight); and a combination thereof; (iii) washed pome fruit tissue mass, said washed pome fruit tissue mass having a moisture content of at least 85% (w/w of total pome fruit tissue mass weight), soluble solid content of up to 2 ° Brix and a total dietary fiber (TDF) of between about 3.5% to about 6% (w/w of total pome fruit tissue mass weight); (iv) washed drupe fruit tissue mass, said washed drupe fruit tissue mass having a moisture content of at least 85% (w/w of total drupe fruit tissue mass weight), soluble solid content of up to 2 ° Brix and a total dietary fiber (TDF) of between about 5% to about 8% (w/w of total drupe fruit tissue mass weight); and (v) washed vegetable tissue mass having a moisture content of at least 85% (w/w of total vegetable tissue mass weight), soluble solid content of up to 2 ° Brix and a total dietary fiber (TDF) of between about 3.5% to about 8% (w/w of total vegetable tissue mass weight); wherein the fortified beverage has a TDF of at least 0.8% (w/w of total fortified beverage weight), and a viscosity below 20 cp at a shear rate of 40 (1/sec).

According to some embodiments, the fortified beverage has a viscosity below 10 cp at a shear rate of 40 (1/sec).

According to some embodiments, the fortified beverage of the present invention comprises a TDF of at least 0.8% (w/w of total fortified beverage weight), and viscosity below 10 cp at a shear rate of 40 (1/sec). The present invention further provides methods of the preparation of such fiber enriched fruit or vegetable juices. Importantly, in order to maintain the quality and freshness of the fortified fruit or vegetable juice of the present invention, all steps of the processes of making the fortified juice are performed at temperature not higher than about 25° C. Temperatures much above 25° C. can cause the fruit or vegetable juice, the fruit or vegetable tissue mass and/or the obtained fortified beverage to brown more rapidly or to develop off-flavors.

The fruit or vegetable juice: Any juice can be used to make the fortified beverage of the present invention. The juice is generally pressed or squeezed from washed fruit or vegetable. In some embodiments, the peel, rag, seeds and large pulp, membrane or cellulosic materials of a citrus fruit are removed in a finishing step, if necessary. Undeveloped seeds and sensible pulp of citrus fruit are removed in the finisher. Preferably, the squeezing of the fruit or vegetable juice is performed under conditions designed to minimize oxidation, i.e., in an inert atmosphere. In some embodiments, the raw juice from citrus fruits such as oranges, lemons, and grapefruits, as it comes from the extractor or squeezing process contains pulp and seeds. These are separated from the juice in a “finisher”. The finisher contains a screen which removes the citrus pulp and seeds from the juice. The screen opening size can range from about 0.1 mm to about 2.5 mm When the screen opening is larger than 2.5 mm, small seeds pass into the juice and contaminate it.

In order to preserve the aroma and flavor of the juice and to minimize the activity of enzymes present in the juice, the juice should be held for as short a time as is possible before it is pasteurized or sterilized. Preferably the time from squeezing the juice through pasteurization is less than 15 minutes. The exact time will depend upon the size and flow rate of the equipment and the efficiency of the pasteurization unit.

The methods and beverages of the present invention are preferably made from all natural products. Preferably, the enriched beverages of the present invention are based on fiber enriched fruit or vegetable tissue mass being added to natural squeezed fruit or vegetable juice (i.e.

conventionally extracted single-strength juice) being pasteurized or unpasteurized. Typically, no flavor components such as sweeteners are added to the fortified juice. However, according to some embodiments, sweeteners may be further added to the fortified juice or fruit drink The sweetener usually comprises a monosaccharide or a disaccharide. These include sucrose, fructose, dextrose, maltose and lactose. Other carbohydrates can be used if less sweetness is desired. Mixtures of these sugars can be used. The one of skill in the art will appreciate that the amount of the sweetener effective in the beverages depends upon the particular sweetener used and the sweetness intensity desired.

According to some embodiments, the fortified fruit or vegetable beverage of the present invention further comprises at least one additive selected from the group consisting of: minerals, vitamins, colorants, flavoring agents, electrolytes and any combinations thereof. Each possibility represents a separate embodiment of the present invention.

According to some embodiments, the vitamins selected from the group consisting of: ascorbic acid (Vitamin C), Vitamins E, Vitamins B1 (thiamin), B2 (riboflavin), B6 (pyridoxamine), B12 (cyanocobalamine) and Vitamin B complexes. Components of a Vitamin B complex include vitamins B 1, B2, B6, B12, biotin, niacin, pantothenic acid, folic acid, adenine, choline, adenosine phosphate, orotic acid, pangamic acid, carnitine, 4-aminobenzoic acid, myo-inositol, liponic acid and/or amygdaline.

Beneficial minerals that may be included in the fortified beverages include calcium, iron, magnesium and zinc. Electrolytes that would be suitable for inclusion include sodium, potassium and magnesium in the form of their chloride and/or bicarbonate salts.

According to some embodiments, additional ingredients may be further included in the beverages. Such ingredients include preservatives such as benzoic acid sorbic acid and salts thereof, sulfur dioxide, butylated hydroxyanisole, butylated hydroxytoluene, etc. colors derived preferably those derived from natural sources can be added. Salt such as sodium chloride, and other flavor enhancers can be used to improve the flavor of the beverage. Emulsifiers can also be included in the beverage. Any food grade emulsifier can be used. Edible emulsifiers include mono and di-glycerides of long chain fatty acids, preferably saturated fatty acids, and most preferably, stearic and palmitic acid mono and diglycerides. Propylene glycol esters are also useful in the beverage mixes.

Packaging

The fortified juice is packaged to ensure long-term stability. Preferably, the packaging materials should be impervious to oxygen and damaging light radiation. Optionally, the fortified juice or concentrate can be packed under an inert gas to minimize the oxygen content of any container headspace. The fortified juice is preferably kept at a temperature of 10° C. or less during long-term storage.

Viscosity Measurement

Fruit or vegetable juices in particular citrus juices comprising added citrus pulp and/or comminuted peel, are non-Newtonian in nature, which means that they have different apparent viscosities (the ratio of shear stress to shear rate) dependent on the shear stress applied. Because of this, the apparent viscosity of such juices is normally quoted together with the measured shear rate (the velocity gradient set up in a solution under applied stress). Fruit or vegetable juices are typically shear-thinning in nature, meaning that as the applied shear stress is increased, the apparent viscosity decreases. The zero-shear viscosity, normally extrapolated from experimental data, is the viscosity as the shear rate tends to zero, and is therefore the highest apparent viscosity for shear-thinning fluids.

The sensory thickness, or oral viscosity, of shear-thinning compositions thus depends on the shear stress applied to the fluid in-mouth and the resultant shear rate. Wood (Wood, F. W. (1968) Psychophysical studies on the consistency of liquid foods. In SCI Monograph No. 27. Rheology and Texture of Foodstuffs. Society of Chemical Industry, London, p. 40.) correlated the perceived texture of hydrocolloids with their rheological flow properties and concluded that the stimulus associated with the oral evaluation of viscosity was a shear stress developed in mouth at a constant shear rate of between 40-60 s⁻¹. Accordingly, it was an objective of the present invention to obtain beverages enriched with fruit or vegetable fiber having a perception of taste and aroma of a natural (non-fortified) fruit or vegetable juice. It has been estimated that such natural perception of taste and aroma may be achieved when the measured viscosity is lower than 10 cp (20° C.) at the mouth's shear rate. Thus, typically, the fortified beverages of the present invention comprises a total dietary fiber of at least 0.8% (w/w of total fortified beverage weight), and viscosity below 10 cp at a shear rate of 40 (1/sec). Preferably, the fortified beverages of the present invention comprises a total dietary fiber of at least 1.0% (w/w of total fortified beverage weight), and viscosity below 7 cp at a shear rate of 40 (1/sec).

The viscosity measurements were done using a Brookfield viscometer (Brookfield LV DV-III viscometer, at 25° C.).

As used herein and in the appended claims the singular forms “a”, “an” and “the” include plural references unless the content clearly dictates otherwise. It should be noted that the term “and” or the term “or” is generally employed in its sense including “and/or” unless the content clearly dictates otherwise.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1

### Increasing Relative Percentage of Dietary Fiber in Orange Pulp.

US orange pulp was placed in 250 ml plastic tubes (Nalgene, USA) with distilled water, added according to a 1:2 ratio weight basis, and centrifuged (Sorvall, model RC 5B, USA) for 10 minutes at 10,000 RPM (5-10° C.). This procedure was repeated several times (˜3). The upper liquid phase was decanted at the end of each centrifugation, until a soluble solid content of ˜0.5° Bx was reached. Additional centrifugation of the pulp may be performed without the addition of distilled water in order to reduce pulp water content. Table 1 summarizes the total dietary fiber and water content of different fiber sources.

TABLE 1
Total dietary fiber and water content in different fiber sources.

| Water | TDF (%) | |
|---|---|---|
| content | wet basis | Sample name |
| 85.9 | 3.4 | American orange pulp |
| 93.4 | 5.6 | Washed American orange pulp |
| 93.6 | | Washed & ground American orange pulp |
| 92.4 | 2.6-3.2 | Comminuted orange peel |
| 92.9 | 5.3-6.7 | Washed comminuted orange peel |
| 85.7 | 2.7 | Whole orange juice sacs |
| 90.8 | 5.0 | Washed whole orange juice sacs |

Table 2 summarizes the chemical and physical characteristics of a US orange pulp after washing the pulp according to the teachings of the present invention.

As can be seen, the total dietary content in the washed pulp is significantly higher (about 50% higher) than the total dietary content of the unwashed pulp. The “solid matter” as presented in Table 2 includes both soluble and non-soluble solids. “Brix” means the total soluble solids as determined when measured by a digital refractometer PR 100 of (Atago Co., Ltd.) and the like.

TABLE 2
US orange pulp chemical and physical characteristics.

| Water | | | | | Solid | |
|---|---|---|---|---|---|---|
| content | TDF | Acidity | | Brix | matter | |
| (%) | (%) | (%) | pH | (°Bx) | % | |
| 85.9 | 3.4 | 0.5 | 4.0 | 12.3 | 14.1 | US orange pulp |
| 93.4 | 5.6 | 0.1 | 3.9 | 0.5 | 6.6 | Washed US orange pulp |

The pulp may be further comminuted in order to reduce the particles' size and to obtain shorted fibers. Comminuting (or grinding) may be performed for example in a ball mill grinder. One non-limited exemplary comminuting procedure includes grinding using a ball mill grinder for 5-10 minutes at 400-600 RPM in a bowl containing 24 silicon nitride balls, 10 mm diameter (Fritsch, model planetary mono mill pulverisette 6 classic line, Idar-Oberstein, Germany)

### Example 2

### Chemical Analysis of Total Dietary Fiber (TDF) in Orange Products

The total dietary fiber (TDF) in commercial juice, washed pulp (prepared according to the methods of the present invention), and commercial juice fortified with washed pulp at different percentages were measured and summarized in Table 3.

TABLE 3
Chemical analysis of total dietary fiber (TDF) in orange products

| Viscosity | | |
|---|---|---|
| measured at | | |
| shear rate of | TDF | |
| 40 (1/s) | (w/w %) | Sample name |
| 4.1 | 0.3-0.4 | Commercial juice |
| | 3.4 | American pulp |
| | 5.6 | Washed American pulp |
| | 2.6-3.2 | Comminuted peel |
| | 5.3-6.7 | Washed comminuted peel |
| | 2.7 | Whole orange juice cells |
| | 5.0 | Washed whole orange juice cells |
| | 0.8 | Fortified commercial orange juice with 7% |
| | | added washed pulp |
| | 0.8 | Fortified commercial orange juice with 7% |
| | | added washed & ground pulp |
| | 0.9 | Fortified commercial orange juice with 9% |
| | | added washed pulp |
| | 0.8 | Fortified commercial orange juice with 9% |
| | | added washed & ground pulp |
| 4.7 | 1.0 | Fortified commercial orange juice with 11% |
| | | added washed pulp |
| 5.6 | 0.9 | Fortified commercial orange juice with 11% |
| | | added washed & ground pulp |
| 6.2 | 1.0 | Fortified commercial orange juice with 13% |
| | | added washed & ground pulp |
| 26.73 | 1.0 | Fortified commercial orange juice with 13% |
| | | added washed comminuted peel |

### Example 3

### Viscosity Measurements of Commercial and Fortified Orange Juice

The viscosity of commercial juice, washed pulp (prepared according to the methods of the present invention), and commercial juice fortified with washed pulp at different percentages were measured and summarized in Table 4.

TABLE 4
Viscosity measurements of commercial and fortified orange juice.

| Viscosity (cp) | | | | | |
|---|---|---|---|---|---|
| | Fortified | | | | |
| Fortified | juice with | Fortified | Fortified | | |
| juice with | 13% | juice with | juice with | | |
| 13% | washed | 11% washed | 11% | | Shear |
| comminuted | & ground | & ground | washed | Commercial | Rate |
| washed peel | pulp | pulp | pulp | juice | (1/s) |
| 75.97 | 16.6 | 11.9 | 10.7 | 7.9 | 10.0 |
| 52.92 | 12.3 | 8.3 | 8.0 | 6.3 | 15.8 |
| 41.28 | 9.4 | 7.7 | 7.3 | 4.8 | 21.6 |
| 34.72 | 7.7 | 6.4 | 5.9 | 5.4 | 27.4 |
| 30.33 | 6.8 | 5.5 | 5.3 | 4.4 | 33.2 |
| 26.73 | 6.2 | 5.6 | 4.7 | 4.1 | 39.0 |
| 24.60 | 6.2 | 4.9 | 4.6 | 3.5 | 44.7 |
| 22.88 | 5.3 | 4.4 | 4.3 | 3.5 | 50.5 |
| 21.23 | 5.1 | 4.6 | 4.2 | 3.3 | 56.3 |
| 19.95 | 4.6 | 4.1 | 3.7 | 3.2 | 62.1 |
| 19.24 | 4.5 | 3.8 | 3.9 | 3.1 | 67.9 |
| 18.48 | 4.1 | 3.8 | 3.9 | 3.2 | 73.7 |
| 17.14 | 4.6 | 4.0 | 3.6 | 3.1 | 79.5 |
| 16.86 | 4.1 | 3.6 | 3.7 | 3.1 | 85.3 |
| 16.13 | 4.0 | 3.6 | 3.7 | 2.9 | 91.1 |
| 15.58 | 3.8 | 3.6 | 3.4 | 3.1 | 96.8 |
| 15.12 | 3.9 | 3.6 | 3.4 | 2.9 | 102.6 |
| 14.97 | 3.7 | 3.3 | 3.3 | 3.0 | 108.4 |
| 14.35 | 3.7 | 3.5 | 3.2 | 2.9 | 114.2 |
| 14.12 | 3.6 | 3.3 | 3.2 | 2.9 | 120.0 |

### Example 4

### Hedonic Scale Sensory Test

The most widely used scale for measuring food acceptability is the 9-point hedonic scale. The scale was adopted by the food industry, and is used not just for measuring the acceptability of foods and beverages, but also for personal care products, household and cosmetics. The acceptability of a product is the examination whether one product preferred over another.

In order to test the acceptability of the fortified juices comprises 11% of washed or washed and ground citrus pulp, prepared according to the methods of the present invention, 3 hedonic scale sensory tests were performed on 3 separate occasions (Tables 5-7) and included 18, 45 and 62 testers respectively.

TABLE 5
Hedonic scale sensory test (18 testers)

| Statistical | Grades | | |
|---|---|---|---|
| analyses* | SD | Mean | Juice type |
| A | 1.5 | 6.4 | Commercial juice |
| A | 1.6 | 6.0 | Fortified juice (commercial juice + 11% washed |
| | | | pulp) |
| A | 2.1 | 6.0 | Fortified juice (commercial juice + 11% washed |
| | | | & ground pulp) |

TABLE 6
Hedonic scale sensory (45 testers)

| Statistical | Grades | | |
|---|---|---|---|
| analyses* | SD | Mean | Juice type |
| A | 2.0 | 6.2 | Commercial juice |
| A | 2.2 | 5.3 | Fortified juice (commercial juice + 11% washed |
| | | | pulp) |
| A | 2.1 | 5.6 | Fortified juice (commercial juice + 11% washed |
| | | | & ground pulp) |

TABLE 7
Hedonic scale sensory (62 testers)

| Statistical | Grades | | |
|---|---|---|---|
| analyses* | SD | Mean | Juice type |
| A | 1.8 | 6.3 | Commercial juice |
| A | 2.0 | 5.5 | Fortified juice (commercial juice + 11% washed |
| | | | pulp) |
| A | 2.1 | 5.7 | Fortified juice (commercial juice + 11% washed |
| | | | & ground pulp) |

In order to test the acceptability of fortified juices comprises 13% comminuted orange peel which has been washed one time or five times according to the methods of the present invention, hedonic scale sensory test was performed.

TABLE 7A
Hedonic scale sensory test

| | Grades | | Statistical |
|---|---|---|---|
| Juice type | Mean | SD | analyses* |
| Commercial orange juice | 7.0 | 1.6 | A |
| Fortified orange juice (13% comminuted peel) | 5.3 | 1.8 | B |
| washed once | | | |
| Fortified orange juice (13% washed comminuted | 4.2 | 2.6 | C |
| peel) washed 5 times | | | |

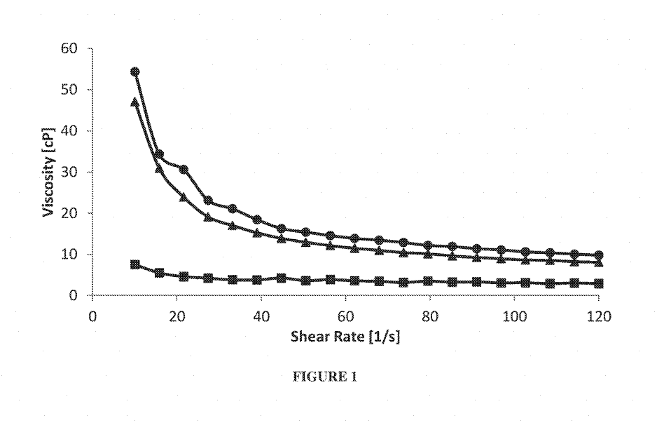

The viscosity of commercial juice and commercial juice fortified with washed orange peel which has been washed one time or five times according to the methods of the present invention were measured and presented in FIG. 1 and summarized in Table 7B.

TABLE 7B
Viscosity measurements of commercial and fortified orange juice.

| Viscosity (cP) | | | |
|---|---|---|---|
| Fortified orange juice | Fortified orange juice | | |
| (13% washed | (13% | | |
| comminuted peel) | comminuted peel) | Commercial | Shear Rate |
| washed 5 times | washed once | juice | (1/s) |
| 54.4 | 47.1 | 7.5 | 10.0 |
| 34.4 | 31.0 | 5.5 | 15.8 |
| 30.6 | 23.9 | 4.6 | 21.6 |
| 23.1 | 19.1 | 4.2 | 27.4 |
| 21.1 | 17.0 | 3.8 | 33.2 |
| 18.4 | 15.2 | 3.8 | 39.0 |
| 16.3 | 13.9 | 4.3 | 44.7 |
| 15.4 | 12.9 | 3.6 | 50.5 |
| 14.6 | 12.1 | 3.9 | 56.3 |
| 13.9 | 11.5 | 3.6 | 62.1 |
| 13.4 | 11.0 | 3.4 | 67.9 |
| 12.9 | 10.4 | 3.2 | 73.7 |
| 12.2 | 10.1 | 3.5 | 79.5 |
| 11.9 | 9.6 | 3.3 | 85.3 |
| 11.4 | 9.2 | 3.3 | 91.1 |
| 11.1 | 8.9 | 3.1 | 96.8 |
| 10.6 | 8.6 | 3.1 | 102.6 |
| 10.4 | 8.5 | 2.9 | 108.4 |
| 10.1 | 8.2 | 3.0 | 114.2 |
| 9.8 | 8.1 | 2.9 | 120.0 |

### Example 5

### Particle-size Distribution in Washed Orange Pulp

Orange pulp was washed and centrifuged at 10,000 RPM, for 10 minutes, at 5-15° C. The washed pulp was then diluted to 1:100 using distilled water and photographed by an InVia

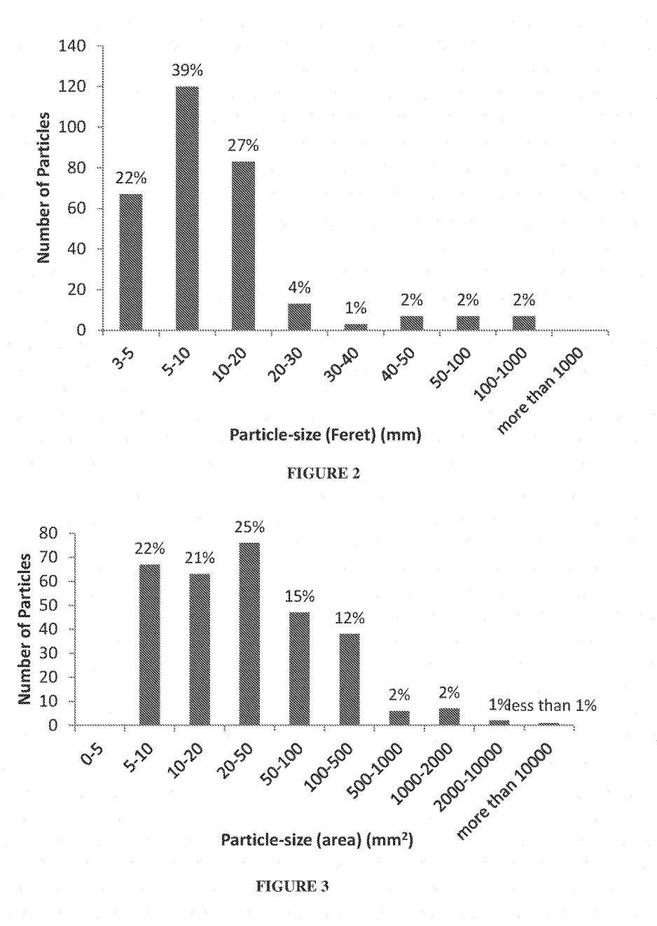

Raman Microscope X5. Resulting images were analyzed using image hardware (ver 1.47m). The Feret diameter was measured, and used to distribute particle size, as showed in FIG. 2. Particle-area distribution was also calculated and is shown in FIG. 3. The columns in FIGS. 2 and 3 represent the number of particles observed in each range and the percentage from total is denoted at the top.

### Example 5B

### Water Holding Capacity and Particle-Size Distribution of Washed & Ground Orange Pulp

### Pulp Wash:

Orange pulp was placed in 250 ml plastic tubes (Nalgene, USA) with distilled water, added according to a 1:1.5 ratio weight basis, and centrifuged (Sorvall, model RC 5B, USA) for 5 minutes at 10,000 RPM (20° C.). This procedure was repeated 3 times. The upper liquid phase was decanted at the end of each centrifugation, until a soluble solid content of ˜0.5° Bx was reached. An additional centrifugation run was then performed without the addition of distilled water to the pulp in order to reduce pulp water content.

### Pulp Grinding:

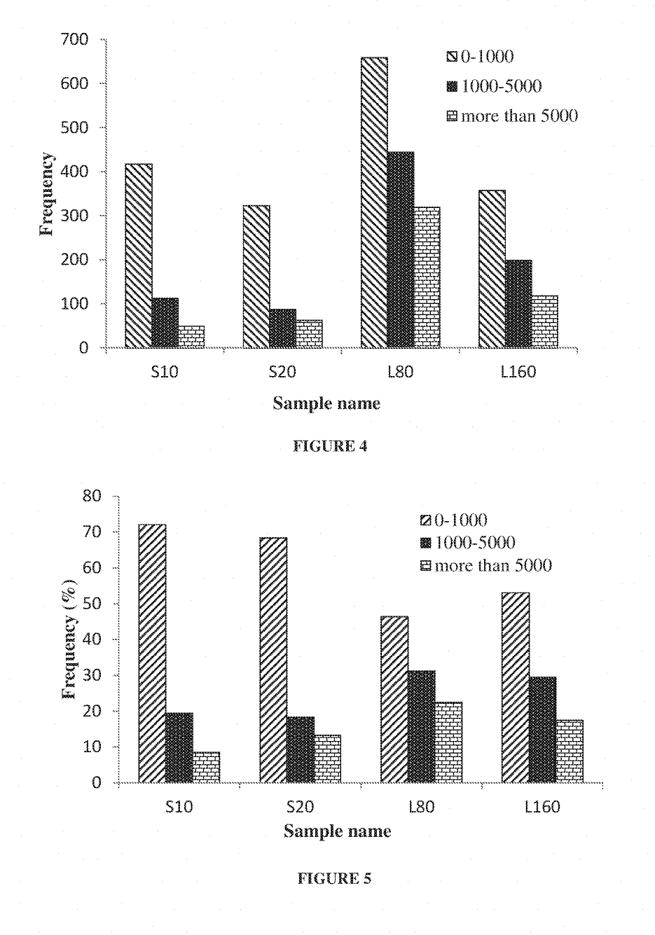

Orange pulp was ground in a ball mill grinder (Fritsch, model planetary mono mill pulverisette 6 classic line, Idar-Oberstein, Germany) for 6 minutes at 450 RPM in a small or large bowl as describe in Table 7C. FIGS. 4 and 5 show the particle-area distribution in four washed and ground orange pulp listed in Table 7D. Water holding capacity of the different ground pulps was determined by adding distilled water to the pulp until reaching a visible leakage or water-pulp separation (Table 7E).

TABLE 7C
Ball mill grinder characteristic.

| Large bowl | Small bowl | |
|---|---|---|
| 500 | 80 | Capacity (ml) |
| 80-225 ml | 10-30 ml | Capacity used |
| 10 | 24 | Number of balls (Silicon nitride) |

TABLE 7D
Washed orange pulp.

| Sample description | Sample name |
|---|---|
| 10 ml orange pulp in small cup | S10 |
| 20 ml orange pulp in small cup | S20 |
| 80 ml orange pulp in large cup | L80 |
| 160 ml orange pulp in large cup | L160 |

TABLE 7E
water holding capacity
of washed & ground
orange pulp.

| Water | |
|---|---|
| holding | |
| (% of initial | Sample |
| pulp weight) | name |
| 270 | S10 |
| 340 | S20 |
| 420 | L80 |
| 375 | L160 |

Statistical analyses were conducted using the JMP software, including ANOVA and the Tukey-Kramer Honestly Significant Difference Method for comparisons of means. A p-value of 0.05 was considered significant.

ANOVA (analysis of variance) is a collection of statistical models, and their associated procedures, in which the observed variance in a particular variable is partitioned into components attributable to different sources of variation. In its simplest form, ANOVA provides a statistical test of whether or not the means of several groups are all equal, and therefore generalizes t-test to more than two groups. Doing multiple two-sample t-tests would result in an increased chance of committing a type I error. For this reason, ANOVAs are useful in comparing two, three, or more means.
Tukey-Kramer method, is a single-step multiple comparison procedure and statistical test. It is used in conjunction with an ANOVA to find means that are significantly different from each other. Named after John Tukey, it compares all possible pairs of means, and is based on a Studentized range distribution (q) (this distribution is similar to the distribution of t from the t-test). The Tukey HSD tests should not be confused with the Tukey Mean Difference tests (also known as the Bland-Altman Test).
Tukey's test compares the means of every treatment to the means of every other treatment; that is, it applies simultaneously to the set of all pairwise comparisons.

### Example 6

### Centrifuge Modified Parameters

The effect of various parameters in the centrifuge operation on the amount of total dietary fiber (TDF), Brix, dry matter and pulp weight in washed US orange pulp was tested. Centrifugation is repeated until a Brix value of 0.5° Brix or less is achieved. Table 8, summarizes the US orange pulp characteristics before washing.

TABLE 8
US orange pulp
characteristic
before washing

| | | Dry |
|---|---|---|
| TDF | | matter |
| (%) | °Brix | (%) |
| 3.2 | 10.8 | 14.2 |

a. Centrifuge Running-time Test

The effect of the centrifuge running time on the amount of total dietary fiber (TDF), Brix, dry matter and pulp weight in washed US orange pulp was tested. The results as presented in table 9 teach that the highest amount of TDF was obtained at centrifuge running time of 5 minutes.

b. Temperature Test

The effect of temperatures on the amount of TDF, Brix, dry matter and pulp weight in washed US orange pulp was tested. The results as presented in table 10 teach that the optimal temperature in centrifuge operation in order to obtain the highest amount of TDF is 20° C.

c. Pulp to Water Ratio Test

The effect of the US orange pulp to water ratio on the amount of TDF, Brix, dry matter and pulp weight in washed US orange pulp was tested. The results as presented in table 11 teach that the optimal ratio of pulp to water is 1:1.5, whereby the highest amount of TDF is obtained.

d. Water Type Test

The effect of the water type on the amount of TDF, Brix, dry matter and pulp weight in washed US orange pulp was tested. As can be seen from table 12 below, the optimal water type for obtaining high amount of TDF with the smallest reduction in pulp loss is distilled water.

e. Last Centrifugation Run Test

The effect of the presence of distilled water in the last centrifugation on the amount of total dietary fiber (TDF), Brix, dry matter and pulp weight in washed US orange pulp was tested. The results as presented in table 13 teach that the highest amount of TDF was obtained when omitting the distilled water during the final centrifugation run.

f. Testing the Effect of Shaking the Pulp with Water vs. Magnetic Stirrer

A comparison between the effect of shaking the pulp with water in a centrifuge tube for about three seconds, and the effect of mixing the pulp with a magnetic stirrer on the amount of TDF, Brix, dry matter and pulp weight in washed US orange pulp was performed. As can be seen from the results presented in table 15, the highest amount of TDF was obtained when the pulp and water underwent shaking in the centrifuge tube for about three seconds. Thus, shaking the pulp with water is more efficient than mixing the pulp with a magnetic stirrer for obtaining high amount of TDF.

g. The Effect of Pulp to Water Ratio in Combination with Pulp Shaking.

The effect of pulp to water ratios in combination with the effect of shaking the pulp with water for about 3 seconds on the amount of TDF, Brix, dry matter and pulp weight in washed US orange pulp was tested. The results as presented in table 17 teach that when shaking the pulp with water for about 3 seconds, the optimal pulp to water ratio in order to obtain the highest amount of TDF is 1:1.5.

h. Number of Centrifuge Runs Test

The effect of the number of the centrifuge runs on the amount of TDF, Brix, dry matter and pulp weight in washed US orange pulp was tested. The results as presented in table 19 teach that the highest amount of TDF was obtained after the first centrifuge run and any additional run caused a reduction of about 4% of TDF content.

i. Chemical Analysis of Total Dietary Fiber (TDF) in Orange Juice Sacs

The effect of the number of the centrifuge runs on the amount of TDF, Brix, dry matter, acidity and PH in washed orange juice sacs was tested. The results as presented in table 19B teach that the highest amount of TDF was obtained after five centrifuge runs.

j. Chemical Analysis of Total Dietary Fiber (TDF) in Orange Comminuted Peel

The effect of the number of the centrifuge runs on the amount of TDF, Brix, dry matter, PH and acidity in washed orange comminuted peel was tested. The results as presented in table 19D teach that the highest amount of TDF was obtained after five centrifuge runs.

TABLE 9
centrifugation running-time test

| | Reduction in pulp weight (%) | | | | ^{o}Brix | | | Dry | Centrifuge |
|---|---|---|---|---|---|---|---|---|---|
| TDF | Centrifuge | Centrifuge | Centrifuge | Centrifuge | Centrifuge | Centrifuge | Centrifuge | matter | operation |
| (%) | run 4 | run 3 | run 2 | run 1 | run 3 | run 2 | run 1 | (%) | conditions |
| 3.0 | 60 | 56 | 51 | 41 | 0.3 | 0.7 | 3.2 | 4.4 | 3.5 min, 20° C., |
| | | | | | | | | | 5000 RPM |
| 4.0 | 58 | 49 | 46 | 37 | 0.3 | 0.7 | 3.0 | 5.1 | 5.0 min, 20° C., |
| | | | | | | | | | 5000 RPM |
| 3.8 | 60 | 56 | 51 | 44 | 0.5 | 0.5 | 3.5 | 5.4 | 10.0 min, 20° C., |
| | | | | | | | | | 5000 RPM |

TABLE 10
centrifugation temperature test

| | Reduction in pulp weight (%) | | | | | ^{o}Brix | | | | Dry | Centrifuge |
|---|---|---|---|---|---|---|---|---|---|---|---|
| TDF | Centrifuge | Centrifuge | Centrifuge | Centrifuge | Centrifuge | Centrifuge | Centrifuge | Centrifuge | Centrifuge | matter | operation |
| (%) | run 5 | run 4 | run 3 | run 2 | run 1 | run 4 | run 3 | run 2 | run 1 | (%) | conditions |
| 3.4 | 68 | 62 | 54 | 50 | 40 | 0.4 | 0.7 | 1.2 | 3.1 | 4.9 | 5 min, 4° C., |
| | | | | | | | | | | | 5000 RPM |
| 4.0 | — | 58 | 49 | 46 | 37 | — | 0.3 | 0.7 | 3.0 | 5.1 | 5 min, 20° C., |
| | | | | | | | | | | | 5000 RPM |
| 3.3 | — | 72 | 67 | 49 | 37 | — | 0.5 | 0.8 | 2.8 | 4.7 | 5 min, 40° C., |
| | | | | | | | | | | | 5000 RPM |

TABLE 11
pulp to water ratio test

| | Reduction in pulp weight (%) | | | | | ^{o}Brix | | | | Dry | (Pulp:water) | Centrifuge |
|---|---|---|---|---|---|---|---|---|---|---|---|---|
| TDF | Centrifuge | Centrifuge | Centrifuge | Centrifuge | Centrifuge | Centrifuge | Centrifuge | Centrifuge | Centrifuge | matter | ratio | operation |
| (%) | run 5 | run 4 | run 3 | run 2 | run 1 | run 4 | run 3 | run 2 | run 1 | (%) | (weight basis) | conditions |
| 3.7 | 57 | 48 | 38 | 30 | 29 | 0.5 | 1.3 | 2.9 | 3.8 | 5.1 | 1:1 | 5 min, 20° C., |
| 4.5 | — | 58 | 54 | 32 | 30 | — | 0.5 | 0.8 | 3.6 | 6.7 | 1:1.5 | 5000 RPM |
| 4.0 | — | 58 | 49 | 46 | 37 | — | 0.3 | 0.7 | 3.0 | 5.1 | 1:2 | |

TABLE 12
water type test

| | Reduction in pulp weight (%) | | | | ^{o}Brix | | | Dry | | Centrifuge |
|---|---|---|---|---|---|---|---|---|---|---|
| TDF | Centrifuge | Centrifuge | Centrifuge | Centrifuge | Centrifuge | Centrifuge | Centrifuge | matter | Water | operation |
| (%) | run 4 | run 3 | run 2 | run 1 | run 3 | run 2 | run 1 | ( %) | type | conditions |
| 3.8 | 66 | 63 | 45 | 28 | 0.5 | 1.2 | 3.0 | 6.2 | Tap | 5 min, 20° C., |
| 4.0 | 58 | 49 | 46 | 37 | 0.3 | 0.7 | 3.0 | 5.1 | Distilled | 5000 RPM |
| 4.1 | 66 | 59 | 42 | 25 | 0.5 | 1.0 | 3.8 | 5.3 | Double | |
| | | | | | | | | | distilled | |

TABLE 13
Last centrifugation run test

| | Reduction in pulp weight (%) | | | | ^{o}Brix | | | Dry | Last | Centrifuge |
|---|---|---|---|---|---|---|---|---|---|---|
| TDF | Centrifuge | Centrifuge | Centrifuge | Centrifuge | Centrifuge | Centrifuge | Centrifuge | matter | centrifugation | operation |
| (%) | run 4 | run 3 | run 2 | run 1 | run 3 | run 2 | run 1 | ( %) | run | conditions |
| 4.0 | 58 | 49 | 46 | 37 | 0.3 | 0.7 | 3.0 | 5.1 | Without the | 5 min, 20° C., |
| | | | | | | | | | addition of | 5000 RPM |
| | | | | | | | | | distilled water | |
| | | | | | | | | | to the pulp | |
| 3.6 | 63 | 58 | 57 | 35 | 0.5 | 1.5 | 3.7 | 6.0 | With the | |
| | | | | | | | | | addition 5% | |
| | | | | | | | | | distilled water | |
| | | | | | | | | | to the pulp | |
| 3.5 | — | 67 | 47 | 32 | 0.4 | 0.8 | 2.8 | 6.0 | No last round | |

TABLE 14
US orange pulp
characteristics

| | | Dry |
|---|---|---|
| TDF | | matter |
| (%) | °Brix | (%) |
| 3.4 | 11.0 | 14.7 |

TABLE 15
Pulp and water mixing

| | Reduction | | | | | | | | |
|---|---|---|---|---|---|---|---|---|---|
| | in pulp | ^{o}Brix | | | | Dry | (Pulp:water) | | Centrifuge |
| TDF | weight | Centrifuge | Centrifuge | Centrifuge | Centrifuge | matter | ratio | pulp & water mixing | operation |
| (%) | (%) | run 4 | run 3 | run 2 | run 1 | (%) | (weight basis) | method | conditions |
| 4.5 | 57 | — | 0.4 | 1.3 | 4.6 | 6.4 | 1:1.5 | shaking centrifuge tube | 5 min, 20° C., |
| | | | | | | | | for ~3 seconds | 10000 RPM |
| 3.7 | 60 | 0.3 | 0.8 | 1.8 | 4.4 | 5.0 | | mixing with a magnetic | |
| | | | | | | | | stirrer for 10 minutes | |

TABLE 16
US orange pulp
characteristic
before washing

| | | Dry |
|---|---|---|
| TDF | | matter |
| (%) | °Brix | (%) |
| 3.8 | 11.5 | 14.9 |

TABLE 17
Pulp to water ratio test

| | Reduction | | | | | | | | |
|---|---|---|---|---|---|---|---|---|---|
| | in pulp | ^{o}Brix | | | | Dry | pulp & water | (Pulp:water) | Centrifuge |
| TDF | weight | Centrifuge | Centrifuge | Centrifuge | Centrifuge | matter | mixing | ratio | operation |
| (%) | (%) | run 4 | run 3 | run 2 | run 1 | (%) | method | (weight basis) | conditions |
| 5.1 | 69 | 0.4 | 0.8 | 2.2 | 4.3 | 7.0 | shaking centrifuge | 1:1.5 | 5 min, 20° C., |
| 4.9 | 67 | 0.3 | 0.7 | 1.5 | 4.0 | 6.9 | tube for ~3 sec | 1:2 | 10000 RPM |

TABLE 18
US orange pulp
characteristic
before washing

| | | Dry |
|---|---|---|
| TDF | | matter |
| (%) | °Brix | (%) |
| 3.8 | 11.5 | 9.14 |

TABLE 19
Number of centrifuge runs test

| | Reduction | | | | | | |
|---|---|---|---|---|---|---|---|
| | in pulp | | Dry | (Pulp:water) | | number of | Centrifuge |
| TDF | weight | | matter | ratio | pulp & water mixing | centrifuge | operation |
| (%) | (%) | ^{o}Brix | (%) | (weight basis) | method | runs | conditions |
| 5.4 | 38 | 3.9 | 10.4 | 1:2 | shaking centrifuge tube | 1 | 5 min, 20° C., |
| 5.2 | 43 | 1.4 | 10.1 | | for ~3 sec | 2 | 10000 RPM |
| 5.0 | 44 | 0.6 | 9.1 | | | 3 | |
| 4.8 | 53 | 0.3 | 8.4 | | | 4 | |
| 4.9 | 67 | 0.3 | 6.9 | | Without the addition of | 5 | |
| | | | | | distilled water to the pulp | | |

TABLE 19A
Orange juice sacs characteristic
before washing

| | | | | Dry | |
|---|---|---|---|---|---|
| TDF | Acidity | | | matter | |
| (%) | (%) | pH | °Bx | (%) | |
| 2.7 | 0.7 | 3.8 | 8.7 | 12.9 | orange juice |
| | | | | | sacs as is |
| | | | | | (before |
| | | | | | washing) |

TABLE 19C
US orange comminuted peel
characteristic before washing

| | | | | Dry | |
|---|---|---|---|---|---|
| TDF | Acidity | | | matter | |
| (%) | (%) | pH | °Bx | (%) | |
| 3.0 | 0.9 | 3.8 | 5.3 | 8.0 | orange |
| | | | | | comminuted |
| | | | | | peel as is |
| | | | | | (before |
| | | | | | washing) |

TABLE 19E
Chemical and physical characteristics
of orange juice fortified
with 13% orange comminuted
peel washed one time or five times.

| | | | | Dry | |
|---|---|---|---|---|---|
| TDF | Acidity | | | matter | |
| (%) | (%) | pH | °Bx | % | |
| 0.4 | 0.9 | 3.7 | 12.2 | 11.5 | Commercial orange juice |
| 1.0 | 0.8 | 3.7 | 11.1 | 10.9 | Fortified orange juice |
| | | | | | (13% comminuted |
| | | | | | peel) washed once |
| 1.0 | 0.8 | 3.7 | 10.6 | 10.5 | Fortified orange juice |
| | | | | | (13% washed |
| | | | | | comminuted peel) |
| | | | | | washed 5 times |

### Example 7

### Increasing Relative Percentage of Dietary Fiber in Mango Puree.

Mango puree was placed in 250 ml plastic tubes (Nalgene, USA) with distilled water, added according to a 1:2 ratio weight basis, and centrifuged (Sorvall, model RC 5B, USA) for 5 minutes at 5,000 RPM (20° C.). This procedure was repeated three times. The upper liquid phase was decanted at the end of each centrifugation, until a soluble solid content of ˜0.5° Bx was reached. Additional centrifugation of the puree was performed without the addition of distilled water in order to reduce puree water content. Table 20 summarizes the total dietary fiber content of different fiber sources.

TABLE 20
Total dietary fiber in different fiber sources.

| TDF (%) | | |
|---|---|---|
| (g/100 g) | Product | |
| 1.7 | Mango (EP) | |
| 1.4 | | |
| 2.9 | | |
| 1.3 ± 0.04 | Panchadara Kalasa | Mango |
| 1.5 ± 0.06 | Dashehari | (EP) |
| 1.6 ± 0.02 | Vikarabad Mahamooda | |
| 1.7 ± 0.01 | Rumani | |
| 2.0 ± 0.06 | Totapuri | |
| 2.0 ± 0.04 | Pedda Rasalu | |
| 2.3 ± 0.14 | Neeligova | |
| 2.90 ± 0.35 | Eruman | |
| 3.0 ± 0.17 | Banganapalli | |
| 2.3 ± 0.11 | Pickle mango (big) | |
| 3.8 ± 0.12 | Pickle mango (small) | |
| 1.6 | Mango (Raw) | |

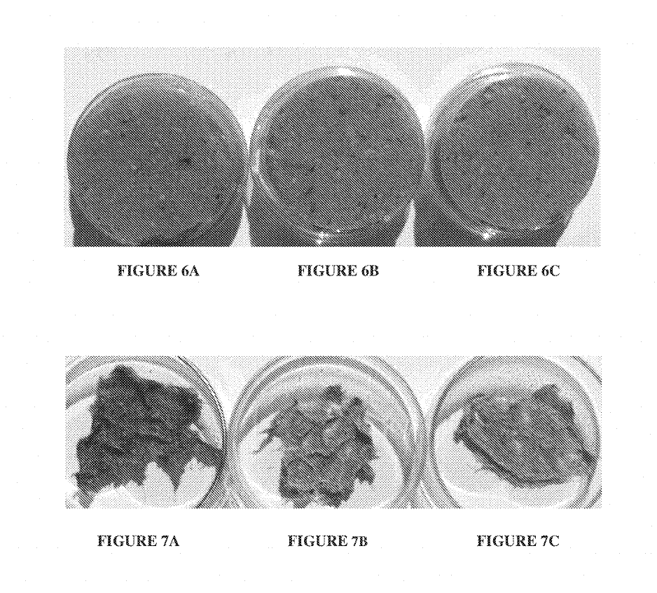

Table 21 summarizes the chemical and physical characteristics of a mango puree after washing the puree according to the teachings of the present invention. As can be seen, the total dietary content in the washed puree is higher than the total dietary content of the unwashed puree. The dried, unwashed puree may undergo browning and produce a sticky product causing impairment of flow properties and caking due to the presence of reducing sugars (FIGS. 6A and 7A), while on the other hand, washing the puree can decrease the browning effect (FIGS. 6B-6C and 7B-7C). The mango puree was dried in an oven at 100° C. for four hours.

TABLE 21
Chemical and physical characteristics of mango puree.

| | Reduction | | | | | | | | |
|---|---|---|---|---|---|---|---|---|---|
| | in puree | | | | | | | | |
| | weight (%) | | | | | | | Dry | |
| TDF | after | Color (X-ray) | | | Acidity | | Brix | matter | |
| (%) | washing | L* | b* | a* | (%) | pH | (° Bx) | % | |
| 5.1 | — | 53 | 23 | 5 | 0.60 | 4.0 | 13.7 | 20.1 | Mango |
| | | | | | | | | | puree |
| | | | | | | | | | as is |
| 5.3 | 27 | 58 | 18 | 3 | 0.06 | 4.0 | 0.4 | 7.4 | Washed |
| | | | | | | | | | mango |
| | | | | | | | | | puree |

a. Centrifugation Speed Test

The effect of the centrifugation speed on the amount of TDF, Brix, dry matter, PH and acidity in washed mango puree was tested. The results as presented in table 23 teach that the highest amount of TDF and the greatest reduction in puree loss was obtained at centrifugation speed of 10,000 RPM.

TABLE 22
Chemical and physical characteristics of Mango puree

| TDF | Color (X-rite) | | | Acidity | | | Dry matter | |
|---|---|---|---|---|---|---|---|---|
| (%) | L* | b* | a* | (%) | pH | ° Bx | (%) | |
| 4.1-5.1 | 25-26 | 23-26 | 3-5 | 0.6-0.9 | 4.0-4.1 | 12.2-14.5 | 18.5-20.1 | Mango puree as is |
| | | | | | | | | (before washing) |

TABLE 23
Centrifugation speed test

| | Reduction | | | | | | |
|---|---|---|---|---|---|---|---|
| | in puree | ^{o}Brix | | | | Dry | Centrifuge |
| TDF | weight | Centrifuge | Centrifuge | Centrifuge | Centrifuge | matter | operation |
| (%) | (%) | run 4 | run 3 | run 2 | run 1 | (%) | conditions |
| 5.3 | 27 | 0.4 | 1.0 | 2.0 | 5.3 | 7.4 | 5 min, 20° C., |
| | | | | | | | 5000 RPM |
| 5.8 | 42 | 0.5 | 0.9 | 1.6 | 5.3 | 9.8 | 5 min, 20° C., |
| | | | | | | | 7500 RPM |
| 6.9-7.2 | 46 | 0.5 | 0.7 | 2.2 | 6.0 | 12.6 | 5 min, 20° C., |
| | | | | | | | 10,000 RPM |

### Example 8

### The Effect of Centrifuge Modified Parameters on Apple Puree

Apple puree was placed in 250 ml plastic tubes (Nalgene, USA) with distilled water, added according to a 1:2 ratio weight basis, and centrifuged (Sorvall, model RC 5B, USA) for 5 minutes at 5,000 RPM (20° C.). This procedure was repeated three times. The upper liquid phase was decanted at the end of each centrifugation, until a soluble solid content of ˜0.5° Bx was reached. Additional centrifugation of the puree was performed without the addition of distilled water in order to reduce pulp water content.

The effect of various parameters in the centrifuge operation on the amount of total dietary fiber (TDF), Brix, dry matter, PH, and acidity in washed apple puree was tested. Table 24 summarizes the chemical and physical characteristics of unwashed diced apple.

TABLE 24
Chemical and physical characteristics
of unwashed diced apple

| | | | | Dry | |
|---|---|---|---|---|---|
| TDF | Acidity | | | matter | |
| (%) | (%) | pH | °Bx | (%) | |
| 1.7-2.0 | 1.0 | 3.3-3.5 | 6.0-6.4 | 7.4-8.0 | Apple |
| | | | | | puree as is |
| | | | | | (before |
| | | | | | washing) |

a. Apple Puree to Water Ratio Test

The effect of the apple puree to water ratio on the amount of total dietary fiber (TDF), Brix, dry matter, PH, and acidity in washed apple puree was tested. The results as presented in table 25 teach that the optimal apple puree to water ratio is 1:2, whereby the highest amount of TDF was obtained.

TABLE 25
Apple puree to water ratio test

| | Reduction | | | | | | |
|---|---|---|---|---|---|---|---|
| | in puree | ^{o}Brix | | | Dry | (apple puree:water) | Centrifuge |
| TDF | weight | Centrifuge | Centrifuge | Centrifuge | matter | ratio | operation |
| (%) | (%) | run 3 | run 2 | run 1 | (%) | (weight basis) | conditions |
| 4.7 | 72 | 0.5 | 1.6 | 2.0 | 6.0 | 1:1.5 | 5 min, 20° C., |
| 4.9 | 71 | 0.3 | 0.9 | 1.9 | 5.4 | 1:2 | 10,000 RPM |

b. Number of Centrifuge Runs Test

The effect of the number of centrifuge runs on the amount of total dietary fiber (TDF), Brix, dry matter, PH, and acidity in washed apple puree was tested. The results as presented in table 26 teach that the highest amount of TDF was obtained after five centrifuge runs.

c. Testing the Effect of Distilled Water in the First Centrifugation Run

The effect of adding distilled water to the firs centrifuge run on the amount of TDF, Brix, dry matter, PH and acidity in apple puree was tested. The results as presented in table 27 teach that highest amount of TDF was obtained with the addition of distilled water to the first centrifuge run.

TABLE 26
number of centrifugation runs

| | Reduction | | | | | | | |
|---|---|---|---|---|---|---|---|---|
| | in puree | | (Puree:water) | | | Dry | number of | Centrifuge |
| TDF | weight | | ratio | Acidity | | matter | centrifuge | operation |
| (%) | (%) | ^{o}Brix | (weight basis) | (%) | pH | (%) | runs | conditions |
| 2.7 | 43 | 2.0 | 1:1.5 | 0.7 | 3.7 | 4.8 | 1 | 5 min, 20° C., |
| 4.7 | 73 | 0.5 | | 0.5 | 4.2 | 3.6 | 5 | 10,000 RPM |

TABLE 27
first centrifugation run test

| | Reduction | | | | | | | | |
|---|---|---|---|---|---|---|---|---|---|
| | in puree | ^{o}Brix | | | | Dry | (Puree:water) | First | Centrifuge |
| TDF | weight | Centrifuge | Centrifuge | Centrifuge | Centrifuge | matter | ratio | centrifugation | operation |
| (%) | (%) | run 4 | run 3 | run 2 | run 1 | (%) | (weight basis) | run | conditions |
| 4.0 | 74 | 0.3 | 0.8 | 1.7 | 5.0 | 5.0 | 1:1.5 | Without the | 5 min, |
| | | | | | | | | addition of | 20° C., |
| | | | | | | | | distilled water† | 10,000 |
| 4.7 | 72 | — | 0.5 | 1.6 | 2.0 | 6.0 | | With the | RPM |
| | | | | | | | | addition of | |
| | | | | | | | | distilled water | |

### Example 9

### Increasing Relative Percentage of Dietary Fiber in Peach Puree.

Peach puree was placed in 250 ml plastic tubes (Nalgene, USA) with distilled water, added according to a 1:2 ratio weight basis, and centrifuged (Sorvall, model RC 5B, USA) for 5 minutes at 10,000 RPM (20° C.). This procedure was repeated four times. The upper liquid phase was decanted at the end of each centrifugation, until a soluble solid content of ˜0.5° Bx was reached. Additional centrifugation of the puree was performed without the addition of distilled water in order to reduce puree water content.

Table 28 summarizes the chemical and physical characteristics of a peach puree after washing the puree according to some embodiments of the present invention. As can be seen in table 28, the total dietary content in the washed puree is higher than the total dietary content of the unwashed puree.

TABLE 28
Chemical and physical characteristics of peach pulp

| | | | | | | | Dry | |
|---|---|---|---|---|---|---|---|---|
| TDF | Color (X-rite) | | | Acidity | | | matter | |
| (%) | L* | b* | a* | (%) | pH | ° Bx | % | |
| 1.9 | 23 | 27 | 6 | 1.1 | 3.5 | 12.0 | 13.0 | Peach pulp as is |
| 5.1 | 26 | 36 | 11 | 0.35 | 4.0 | 0.3 | 6.9 | Washed peach pulp |

a. Number of Centrifuge Runs Test

The effect of the number of centrifuge runs on the amount of TDF, Brix, dry matter, pH, acidity and puree weight in washed peach puree was tested. The results as presented in table 29 teach that the highest amount of TDF was obtained after five centrifuge runs as compared to the TDF mount obtained following one centrifuge run.

### Example 10

### Chemical and Physical Characteristics of Various Fruit Tissue Mass.

TABLE 30
Chemical and physical characteristics of
orange pulp after one centrifuge run and
five centrifuge runs.

| After 5 | After 1 | | |
|---|---|---|---|
| centrifuge | centrifuge | Pulp | |
| runs | run | as is | |
| 33 | 62 | 100 | Pulp weight after |
| | | | the washing process (g) |
| 4.1 | 3.9 | 3.9 | pH |
| 0.1 | 0.3 | 0.7 | Acidity (%) |
| 6.9 | 10.4 | 14.9 | Dry matter (%) |
| 0.5 | 3.9 | 11.5 | °Bx |
| 4.9 | 5.4 | 3.8 | TDF (%) |

TABLE 31
Chemical and physical characteristics
of mango puree after one centrifugation
run and five centrifugation runs.

| After 5 | After 1 | | |
|---|---|---|---|
| centrifuge | centrifuge | Puree | |
| runs | run | as is | |
| 45 | 66 | 100 | Puree weight after |
| | | | the washing process (g) |
| 4.4 | 4.4 | 4.1 | pH |
| 0.5 | 0.6 | 0.8 | Acidity (%) |
| 14.5 | 15.0 | 18.5 | Dry matter (%) |
| 0.5 | 6.3 | 14.5 | °Bx |
| 7.3 | 6.9 | 4.1 | TDF (%) |

TABLE 32
Chemical and physical characteristics
of peach puree after one centrifugation
run and five centrifugation runs.

| After 5 | After 1 | | |
|---|---|---|---|
| centrifuge | centrifuge | Puree | |
| runs | run | as is | |
| 36 | 45 | 100 | Puree weight after the |
| | | | washing process (g) |
| 4.0 | 33.9 | 3.5 | pH |
| 0.5 | 0.8 | 1.1 | Acidity (%) |
| 7.3 | 10.0 | 13.0 | Dry matter (%) |
| 0.5 | 5.3 | 12.0 | °Bx |
| 5.7 | 4.7 | 1.9 | TDF (%) |

TABLE 33
Chemical and physical characteristics
of apricot puree after one centrifugation
run and five centrifugation runs.

| After 5 | After 1 | | |
|---|---|---|---|
| centrifuge | centrifuge | Puree | |
| runs | run | as is | |
| 13 | 17 | 100 | Puree weight after |
| | | | the washing process (g) |
| 4.1 | 3.9 | 3.8 | Ph |
| 0.6 | 1.0 | 1.7 | Acidity (%) |
| 6.2 | 10.5 | 12.1 | Dry matter (%) |
| 0.5 | 4.7 | 11.8 | °Bx |
| 5.4 | 4.3 | 0.9 | TDF (%) |

TABLE 34
Chemical and physical characteristics
of apple puree after one centrifugation
run and five centrifugation runs.

| After 5 | After 1 | | |
|---|---|---|---|
| centrifuge | centrifuge | Puree | |
| runs | run | as is | |
| 27 | 57 | 100 | Puree weight after |
| | | | the washing process (g) |
| 4.2 | 3.7 | 3.5 | pH |
| 0.5 | 0.7 | 1.0 | Acidity (%) |
| 3.6 | 4.8 | 7.5 | Dry matter (%) |
| 0.5 | 2.0 | 6.4 | °Bx |
| 4.7 | 2.7 | 1.7 | TDF (%) |

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one of ordinary skill in the art.

1.-50. (canceled)

51. A fortified beverage, comprising:
(a) fruit or vegetable juice; and
(b) at least one added washed citrus tissue mass selected from: (i) washed citrus pulp, said washed citrus pulp having a moisture content of at least 85% (w/w of total pulp weight), soluble solid content of up to 2 ° Brix and a total dietary fiber (TDF) of between 3.5-8% (w/w of total pulp weight); and (ii) washed comminuted citrus peel, said washed comminuted citrus peel having a moisture content of at least 85% (w/w of total comminuted citrus peel) and a TDF of between 5-10% (w/w of total comminuted citrus peel weight),
wherein the fortified beverage has a TDF of at least 0.8% (w/w of total fortified beverage weight), and a viscosity below 20 cp, wherein the viscosity is measured by Brookfield LV DV-III viscometer at a shear rate of 40 (1/sec) and temperature of 25° C.

52. The fortified beverage of claim 51, further comprising washed citrus juice sacs having a moisture content of at least 85% (w/w of total citrus juice sacs weight), soluble solid content of up to 2 ° Brix and a total dietary fiber (TDF) of between about 3.5% to about 6% (w/w of total citrus juice sacs weight).

53. The fortified beverage of claim 51, comprising:
(a) at least 65% fruit or vegetable juice;
(b) 7%-15% (w/w of total fortified beverage weight) of washed citrus pulp, said washed citrus pulp having a moisture content of at least 85% (w/w of total pulp weight), soluble solid content of up to 2 ° Brix and a total dietary fiber (TDF) of between 3.5-8% (w/w of total pulp weight); and
(c) 0%-10% (w/w of total fortified beverage weight) washed comminuted citrus peel having a TDF of between 5-9% (w/w of total comminuted citrus peel weight);
wherein the fortified beverage has a TDF of at least 0.8% (w/w of total fortified beverage weight), and a viscosity below 20 cp.

54. The fortified beverage of claim 53, further comprising 0%-10% (w/w of total fortified beverage weight) juice sacs having a moisture content of at least 85% (w/w of total citrus juice sacs weight), soluble solid content of up to 2 ° Brix and a total dietary fiber (TDF) of between about 3.5% to about 6% (w/w of total citrus juice sacs weight).

55. The fortified beverage of claim 53, wherein the washed citrus pulp has a soluble solid content of not more than 0.5 ° Brix.

56. The fortified beverage according to claim 51, having a TDF of at least 1% (w/w of total beverage weight) and/or a viscosity below 7 cp.

57. The fortified beverage according to claim 51, wherein the fruit juice is selected from the group consisting of natural squeezed juice being pasteurized or unpasteurized, reconstituted juice from concentrate, dehydrated juice and nectar juice.

58. The fortified beverage according to claim 51, wherein said fruit juice is selected from the group consisting of apple juice, citrus juices, mango juice, peach juice, apricot juice, pear juice, cranberry juice and any mixtures thereof.

59. The fortified beverage according to claim 58, wherein said citrus juice is selected from the group consisting of orange juice, lemon juice, grapefruit juice, tangerine juice, clementine juice, pomelo juice, sweetie juice, lime juice and mixtures thereof.

60. A process for enriching citrus tissue mass with dietary fiber, said citrus tissue mass is being adapted for addition to a fruit or vegetable juice to increase the fiber content thereof; said process comprising the steps of:
a. obtaining a wet citrus tissue mass, selected from the group consisting of citrus pulp, citrus peel, juice sacs, and any combination thereof, the citrus tissue mass having a water content of from about 50% to about 90%;
b. washing the citrus tissue mass, said washing step comprising adding water to the citrus tissue mass in a centrifuge tube followed by centrifugation; and
c. centrifuging the washed citrus tissue mass without adding water to said centrifugation run,
thereby obtaining a washed citrus tissue mass enriched with dietary fiber, with the proviso that the process does not include subjecting the citrus tissue mass to temperatures above 40° C.

61. The process of claim 60, wherein the citrus pulp comprises plant matter remaining after extraction of juice by pressure.

62. The process of claim 60, wherein the citrus tissue mass is selected from the group consisting of:
i. citrus pulp having a water content of from about 50% to about 90% and comprises, on a wet basis, from about 60% to about 99.99% citrus sacs and membranes, from 0% to about 40% citrus peel and from 0% to about 10% citrus seed; and
ii. citrus peel having a water content of from about 50% to about 90% and comprises, on a wet basis, from about 50% to about 99.99% peel.

63. The process of claim 60, wherein the centrifugation time is from about 5 minutes to about 20 minutes and/or the centrifugation speed is between about 5,000 to about 10,000 RPM.

64. process of claim 60, wherein the washing step is repeated from about 1 time to about 7 times.

65. The process of claim 60, wherein the addition of water to the wet citrus tissue mass is at ratio of between about 1:1 and about 1:3.

66. The process of claim 60, further comprising a step of shaking the citrus tissue mass for about one to about five seconds.

67. A process for making a fortified beverage comprising the steps of:
obtaining a fruit or vegetable juice;
adding to the fruit or vegetable juice at least one washed citrus tissue mass prepared by a process of claim 60,
thereby obtaining a fortified beverage having a TDF of at least 0.8% (w/w of total fortified beverage weight).

68. The process of claim 67, wherein 9%-13% (w/w of total fortified beverage weight) of the washed citrus tissue mass is added to the juice.

69. The process of claim 67, wherein the fruit or vegetable juice has less than 0.5% TDF (w/w of total fruit juice weight).

70. The process of claim 67, wherein the washed citrus tissue mass has a moisture content of at least 90% (w/w of the total citrus tissue mass weight), a soluble solid content of not more than 0.5 ° Brix or a combination thereof.
